(19) United States
(12) Patent Application Publication
(10) Pub. No.: US 2025/0295109 A1
(43) Pub. Date: Sep. 25, 2025

(54) UNIVERSAL SYNERGIST FOR INSECT ATTRACTANTS

(71) Applicant: North Carolina State University, Raleigh, NC (US)

(72) Inventors: Coby Schal, Cary, NC (US); Mohamed Saveer Ahmed, Raleigh, NC (US)

(73) Assignee: North Carolina State University, Raleigh, NC (US)

(21) Appl. No.: 18/873,100

(22) PCT Filed: Jun. 9, 2023
(86) PCT No.: PCT/US2023/024979

§ 371 Date: Dec. 9, 2024

Related U.S. Application Data
(60) Provisional application No. 63/350,661, filed on Jun. 9, 2022.

(51) Int. Cl. A01N 35/02; A01N 25/02; A01N 31/02; A01N 63/20; A01P 19/00

(52) U.S. Cl. CPC A01N 35/02; A01N 25/02; A01N 31/02; A01N 63/20; A01P 19/00

(57) ABSTRACT

The use of nonanal and similar aldehydes as an insect attractant is described. For example, compositions and methods for attracting and/or trapping insects involving the use of two active components. one including a C7-C11 aldehyde, e.g., nonanal, and a second including an aggregation pheromone, a kairomone, a food, and/or a fermentation-based attractant are described. In addition, methods and compositions for attracting male insects of the genus Helicoverpa, Chloridea, or Heliothis using a C7-C11 aldehyde and/or 1-hexanol, along with another sex pheromone component, are described.

### CROSS-REFERENCE TO RELATED PATENT APPLICATIONS

This application claims priority to and benefit of U.S. Provisional Application Ser. No. 63/350,661, filed Jun. 9, 2022, the disclosure of which is incorporated herein by reference in its entirety.

### TECHNICAL FIELD

The presently disclosed subject matter relates to compositions, devices, and methods for attracting insects (e.g., beetles, fruit flys or house flys) using a C7-C11 aldehyde, e.g., nonanal, optionally in combination with another active component, such as an aggregation pheromone, a kairomone, a food, and/or a fermentation-based attractant. The presently disclosed subject matter further relates to compositions, devices, and methods for attracting male insects of the species Helicoverpa, Heliothis, and Chloridea using combinations of active components including a first component comprising a C7-C11 aldehyde, e.g., nonanal, optionally in combination with 1-hexanol and a second component comprising a conventional sex pheromone component for the insect.

### ABBREVIATIONS

%=percentage
° C.=degrees Celsius
μg=microgram
μL=microliter
2-comp=two component
Ald=aldehyde
CEW=corn earworm
cm=centimeter
DMSO=dimethyl sulfoxide
EAD=electroantennogram detector
FID=flame ionization detector
GC=gas chromatography
I.D.=inner diameter
m=meter
mg=milligram
min=minutes
mL=milliliter
mm=millimeter
MS=mass spectrometry
ng=nanogram
OAc=acetate
O.D.=outer diameter
psi=pounds per square inch
PTFE=polytetrafluoroethylene
s=seconds
SE=standard error
wt=weight

### BACKGROUND

Insect pests are a major cause of crop damage and loss. In the U.S. alone, billions of dollars are lost every year due to infestation by various genera of insects. In addition to losses in field crops, insect pests are also a burden to vegetable farms and fruit growers, and to producers of ornamental flowers, and are a nuisance to gardeners and homeowners.

In particular, various genera of moths that feed on crops can be particularly destructive, at least in part due to their high reproductive rate. Since they can rapidly build up large populations, the feeding caterpillars can sometimes lead to devestating crop losses. For example, Helicoverpa zea (corn earworm), which is found throughout the temperate and sub(tropical) parts of the Americas, feeds on over 100 crop plants, including corn, cotton, and tomato. In addition, it is also known to feed on beans, broccoli, cabbage, eggplant, lettuce, okra, pea, pepper, soybean and watermelon. Chloridea virescens (tobacco budworm) is from a moth genus closely related to the genus Helicoverpa. Chloridea virescens (previously classified as Heliothis virescens) can cause considerable losses in cotton, tobacco, and soybean crops, as well as in alfalfa, cabbage, lettuce, okra, pea, pepper, squash, tomato, and many other crops.

In addition to being detrimental to crops, insect pests, such as the common house fly, can also serve to spread disease in human and animal populations; damage houses, barns, and other structures of use to those populations, as well as generally causing annoyance or anxiety to members of those populations. While chemical pesticides have been long used to combat insect pests, there remains an ongoing need for new compositions and methods to control insect pests.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this summary does not list or suggest all possible combinations of such features.

In some embodiments, the presently disclosed subject matter provides a composition for attracting an insect, wherein said composition comprises: a first active component, wherein said first active component comprises at least one C7-C11 aldehyde; and a second active component, wherein the second active compound comprises at least one of an aggregation pheromone, a kairomone, a food, and a fermentation-based attractant. In some embodiments, the first active component comprises or consists of nonanal.

In some embodiments, the insect is an agricultural or forest pest. In some embodiments, the insect is an agricultural pest and said agricultural pest is a Cotinis species or a Drosophila species, optionally Cotinis nitida or Drosophila melanogaster. In some embodiments, the insect is a Musca species, optionally Musca domestica.

In some embodiments, the first active component and/or the second active component is formulated in a slow-release formulation, optionally wherein said slow-release formulation comprises an oil. In some embodiments, the composition further comprises a killing agent, a slow-acting insecticide, and/or a biological agent, optionally wherein said biological agent is selected from a bacteria, a fungi, a virus, a nucleic acid, a peptide, and a nematode, optionally wherein said killing agent is a fast-acting insecticide.

In some embodiments, the presently disclosed subject matter provides a method of attracting an insect, the method comprising providing one or more baits or lures, wherein said one or more baits or lures comprise a single active component, wherein said single active component is a C7-C11 aldehyde. In some embodiments, the C7-C11 aldehyde is nonanal.

In some embodiments, the presently disclosed subject matter provides a method of attracting an insect, the method comprising providing one or more baits or lures, wherein said one or more baits or lures collectively comprise (a) a first active component, wherein said first active component comprises at least one C7-C11 aldehyde; and (b) a second active component, wherein said second active component comprises at least one of an aggregation pheromone, a kairomone, a food, and a fermentation-based attractant. In some embodiments, the first active component is nonanal.

In some embodiments, insect is an agricultural pest, optionally wherein the agricultural pest is a Cotinis species or a Drosophila species, further optionally wherein the insect is Cotinis nitida or Drosophila melanogaster. In some embodiments, the insect is a Musca species, optionally Musca domestica.

In some embodiments, one or both of the first and the second active component is formulated in a slow-release formulation, optionally wherein the first component is formulated in an oil or an alkane. In some embodiments, the second component comprises a vinegar or 2-propanol. In some embodiments, the one or more baits or lures are provided in association with a housing for trapping one or more insect.

In some embodiments, the presently disclosed subject matter provides a method of attracting a male insect of the genus Helicoverpa, Chloridea, or Heliothis, the method comprising providing one or more baits or lures, wherein said one or more baits or lures collectively comprise: (a) a first active component, wherein said first active component comprises at least one C7-C11 aldehyde and/or 1-hexanol; and (b) a second active component, wherein said second active component comprises a sex pheromone of said insect. In some embodiments, the male insect is a corn earworm or a tobacco budworm. In some embodiments, the first active component comprises or consists of nonanal and/or wherein the second active component comprises or consists of (Z)-11-hexadecenal (Z11-16:Ald) and/or (Z)-9-tetradecenal (Z9-14:Ald).

In some embodiments, the presently disclosed subject matter provides a composition for attracting a male insect of the genus Helicoverpa, Chloridea, or Heliothis, wherein the composition comprises (i) a first active component comprising 1-hexanol; and (ii) a second active component comprising at least one of (Z)-11-hexadecenal and (Z)-9-tetradecenal. In some embodiments, the first active component further comprises nonanal.

Accordingly, it is an object of the presently disclosed subject matter to provide compositions for attracting insects and related methods. This and other objects are achieved in whole or in part by the presently disclosed subject matter. Further, an object of the presently disclosed subject matter having been stated above, other objects and advantages of the presently disclosed subject matter will become apparent to those skilled in the art after a study of the following description, Figures, and Examples.

### BRIEF DESCRIPTION OF THE FIGURES

Reference will now be made to the accompanying drawings, which are not necessarily drawn to scale.

FIG. 1 is a graph showing the number of male corn earworms (CEW, Helicoverpa zea) caught per trap per day using a commercial sex pheromone lure alone or using the commercial sex pheromone lure in combination with nonanal (present at 0.1 percent (%), 0.5%, or 1% on a weight to weight basis with the main active component of the commercial lure).

FIG. 2 is a graph showing the number of male tobacco budworms (Chloridea virescens) caught per trap per day using a lure comprising a two-component (2-comp) blend of sex pheromones (i.e., (Z)-11-hexadecenal and (Z)-9-tetradecenal) or using the two-component blend lure in combination with nonanal (1 percent (%) on a weight to weight basis compared to the main component, i.e., (Z)-11-hexadecenal, of the 2-comp blend). For comparison, data for traps with no active component attractant (blank) is also provided.

FIG. 3 is a graph showing the number of green June beetles (Cotinis nitida) caught per trap per day in traps containing a 2-propanol lure and in traps containing a 2-propanol lure in combination with 8.3 milligrams (mg) nonanal or 16.6 mg nonanal.

FIG. 4 is a schematic drawing showing a design for a dual choice free flight cage trapping assay used herein to determine the effect of nonanal on trapping fruit flies (Drosophila melanogaster). A 13 centimeter (cm) by 19 cm by 9.5 cm cage with a mesh opening on the top is equipped with two glass 5.5 cm by 2.5 cm glass vial traps, each equipped with a lid fitted with a truncated pipette tip. At the bottom of each glass vial trap is either water or a fermentation attractant (i.e., balsamic vinegar). Inside each glass vial trap is another smaller glass vial containing either a solution of nonanal in dimethyl sulfoxide (DMSO) or a DMSO without nonanal.

FIG. 5 is a graph showing the percentage (%) of trapped fruit flies (Drosophila melanogaster) trapped in the two different vial traps of the assay shown in FIG. 4, when both traps contained water. Data is shown for separate experiments where the amount of nonanal dissolved in dimethyl sulfoxide (DMSO) in the smaller vial in one of the traps was 0.01 micrograms (μg), 0.1 μg, 1 μg, 10 μg, 100 μg, or 1000 μg. The % s of trapped insects trapped in the traps with nonanal are shown to the left, while the % s of trapped insects trapped in the traps without nonanal are shown on the right. For comparison, data for an experiment where both traps contained only water is also shown (bottom).

FIG. 6 is a graph showing the percentage (%) of trapped fruit flies (Drosophilia melanogaster) trapped in the two different vial traps of the assay shown in FIG. 4, when both traps contained balsamic vineger. Data is shown for separate experiments where the amount of nonanal dissolved in dimethyl sulfoxide (DMSO) in the smaller vial in one of the traps was 0.01 micrograms (μg), 0.1 μg, 1 μg, 10 μg, 100 μg, or 1000 μg. The % s of trapped insects trapped in the traps with nonanal are shown to the left, while the % s of trapped insects trapped in the trap without nonanal are shown on the right. For comparison, data for an experiment where both traps contained only balsamic vinegar is also shown (bottom).

FIG. 7A is a schematic drawing showing a design for a dual choice free flight cage trapping assay used to determine the effect of nonanal on the trapping of fruit flies (Drosophila melanogaster) when used in combination with a commercial fruit fly lure. Inside a 30 centimeter (cm) by 30 cm cage are placed two commercial fruit fly traps. Inside each commercial fruit fly trap is placed 1 milliliter (mL) of a commercial fruit fly lure. In addition, in one trap (Trap 1) is placed a 1.5 mL vial containing 50 microliters (μL) dimethyl sulfoxide (DMSO), while in the other trap (Trap 2) is placed a 1.5 mL vial containing 50 μL of a solution of nonanal in DMSO. For each experiment 40 to 120 fruit flies are used.

FIG. 7B is a graph showing the percentage (%) of trapped fruit flies (Drosophila melanogaster) trapped in the two different traps of the assay shown in FIG. 7A. Data is shown for separate experiments where the amount of nonanal dissolved in dimethyl sulfoxide (DMSO) in the 1.5 milliliter (mL) vial in one of the traps was 0.04 milligrams (mg), 0.2 mg, 0.4 mg, 0.83 mg, 1.65 mg, 3.3 mg, or 4.13 mg. The % s of flies trapped in the traps with nonanal are shown to the left, while the % of flies trapped in the traps without nonanal are shown on the right. As a control, data for an experiment where both traps contained only the commercial lure is shown at the bottom.

FIG. 8A is a schematic drawing showing a design for a dual choice free flight cage trapping assay used to determine the effect of nonanal on the trapping of house flies (Musca domestica) when used in combination with a commercial house fly lure. At the right of the drawing is shown a schematic of a 30 centimeter (cm) by 30 cm cage containing two commercial house fly traps (Trap 1 and Trap 2), each including a plastic cup fitted with a transparent lid that has an opening for the flies. An enlarged view of an individual trap is shown to the left side of the drawing. Inside each trap, at the bottom, is placed a commercial fly attractant as a lure. In addition, each trap is fitted with a 1.5 mL vial containing either 50 microliters (μL) dimethyl sulfoxide (DMSO) or 50 μL of a solution of nonanal in DMSO. For each experiment, 20 house flies are used.

FIG. 8B is a graph showing the percentage (%) of trapped house flies (Musca domestica) trapped in the two different traps of the assay shown in FIG. 8A. Data is shown for separate experiments where the amount of nonanal dissolved in dimethyl sulfoxide (DMSO) in the 1.5 milliliter (mL) vial in one of the traps was 0.005 micrograms (μg), 0.05 μg, 0.5 μg, 5 μg, 50 μg, 500 μg, or 5000 μg. The % s of flies trapped in the traps with nonanal are shown to the left, while the % of flies trapped in the traps without nonanal are shown on the right. As a control, data for an experiment where both traps contained the commercial fly attractant lure is shown at the bottom.

FIG. 9A is a graph showing (top) the gas chromatography (GC)-electroantennogram detector (EAD) recording of the antennal electrophysiological responses of male com earworm (CEW, Helicoverpa zea) to a female sex pheromone gland extract and (bottom) the gas chromatogram of a female sex pheromone gland extract, showing the presence of 1-hexanol and nonanal in the gland, using a flame ionization detector (FID).

FIG. 9B is a graph showing the mean ratio of (±standard error (SE)) of 1-hexanol and nonanal relative to the main component, (Z)-hexadecenal (Z11-16:Ald) of the corn earworm (CEW, Helicoverpa zea) female sex pheromone gland extract.

FIG. 10A is a graph comparing the effectiveness of two trap types, a Hartstack trap versus a bucket trap, on male corn earworm (CEW, Helicoverpa zea) captures (measured in number of male CEW captured per day per trap) using only a commercially available pheromone lure inside the traps.

FIG. 10B is a composite photographic image of (left) a Hartstack trap used in field trapping studies of male corn earworm (CEW, Helicoverpa zea) according to the presently disclosed subject matter and (right) the lure dispensers inside the trap One dispenser is a rubber septum loaded with a two-component commercial sex pheromone for CEW and the other dispenser is an aluminum foil-wrapped glass vial filled with a paraffin oil solution comprising 0 percent (%) nonanal to 8% nonanal (weight to weight relative to the main component of the commercial sex pheromone). The cap of the glass vial dispenser is pierced with a capillary tube.

FIG. 10C is a graph showing the effectiveness of different doses of nonanal in field trapping of male corn earworm (CEW, Helicoverpa zea) using a commercial sex pheromone lure with different doses of nonanal. Effectiveness is measured as the number of male CEW captured per trap per day. The data for the two bars on the left are from traps with no commercial pheromone dispenser, while the data for the six bars on the right are from traps with the commercial pheromone dispenser in combination with the dispenser containing either paraffin oil alone (0 percent (%) nonanal) or a paraffin oil solution comprising 0.5% to 8% nonanal (weight to weight relative to the amount of the main component of the commercial sex pheromone).

FIG. 11 is a graph showing the results of a field trapping study of male com earworm (CEW, Helicoverpa zea) using traps containing a dispenser containing a solution of 0.5% nonanal and/or 0.5% 1-hexanol alone or also containing a dispenser for a commercial CEW sex pheromone lure. Effectiveness is reported as number of male CEW capture per day per trap.

### DETAILED DESCRIPTION

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein.

### I. DEFINITIONS

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art. While the following terms are believed to be well understood by one of ordinary skill in the art, the following definitions are set forth to facilitate explanation of the presently disclosed subject matter.

Definitions of specific chemical functional groups and chemical terms are those that would be understood by one of ordinary skill in the art. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Thomas N. Sorrell (2006) Organic Chemistry, 2^{nd} Edition, University Science Books, South Orange, New Jersey; Smith & March (2001) March's Advanced Organic Chemistry, 5th Edition, John Wiley & Sons, Inc., New York; Larock (1989) Comprehensive Organic Transformations, VCH Publishers, Inc., New York; Carruthers (1987) Some Modern Methods of Organic Synthesis, 3^{rd} Edition, Cambridge University Press, Cambridge, 1987; the entire contents of each of which are incorporated herein by reference.

As used herein and in the appended claims, the singular forms “a,” “an,” and “the” include plural referents unless the context clearly dictates otherwise. For example, a pheromone component refers to one or more pheromone components. As such, the terms “a”, “an”, “one or more” and “at least one” can be used interchangeably.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

Unless otherwise indicated, all numbers expressing quantities of concentration, volume, weight, length, width, diameter, thickness, temperature, enzymatic activity, pH, time, mass ratio, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about”, when referring to a value is meant to encompass variations of in one example ±20% or ±10%, in another example ±5%, in another example ±1%, and in still another example ±0.1% from the specified amount, as such variations are appropriate to perform the disclosed methods.

Numerical ranges recited herein by endpoints include all numbers and fractions subsumed within that range (e.g. 1 to 5 includes 1, 1.5, 2, 2.75, 3, 3.90, 4, 4.24, and 5). Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, 1-4, and 2-4).

The terms “optional” and “optionally” as used herein indicate that the subsequently described event, circumstance, element, and/or method step may or may not occur and/or be present, and that the description includes instances where said event, circumstance, element, or method step occurs and/or is present as well as instances where it does not.

The terms “polymer” and “polymeric” refer to chemical structures that have repeating units (i.e., multiple copies of a given chemical substructure). As used herein, polymers can, in some embodiments, refer to structures having more than 3, 4, 5, 6, 7, 8, 9, or 10 repeating units and/or to structures wherein the repeating unit is other than methylene. Polymers can be formed from polymerizable monomers. A polymerizable monomer is a molecule that comprises one or more reactive moieties {e.g., siloxy ethers, hydroxyls, amines, vinylic groups (i.e., carbon-carbon double bonds), halides (i.e., Cl, Br, F, and I), esters, carboxylic acids, activated esters, and the like} that can react to form bonds with other molecules. Generally, each polymerizable monomer molecule can bond to two or more other molecules. In some cases, a polymerizable monomer will bond to only one other molecule, forming a terminus of the polymeric material. Some polymers contain biodegradable linkages, such as esters or amides, such that they can degrade over time under biological conditions.

The terms “sex pheromone” as used herein can refer to a volatile, intraspecies specific signal molecule or blend of molecules produced and released by an insect (e.g., a female insect) at the time of, or prior to, mating that attracts an opposite sex insect (e.g., a male insect).

In some embodiments, chemical compounds (e.g., sex pheromone compounds) are referred to herein by the number of carbon atoms present in the compound or in a main carbon chain of the compound. For example, C7-C11 aldehydes are compounds that contain a seven, eight, nine, ten, or eleven carbon atom chain, respectively, where one of the carbon atoms in the chain is the carbon atom of an aldehyde group.

Pheromones described herein can be referred to using IUPAC nomenclature or various abbreviations and derivations. For example, (Z)-hexadec-11-en-1-al, can also be written as Z-11-hexadecen-1-al, Z-11-hexadecenal, or Z-x-y:Ald, wherein x represents the position of the double bond, and y represents the number of carbons in the hydrocarbon skeleton. Abbreviations used herein and known to those skilled in the art to identify functional groups on the hydrocarbon skeleton include “Ald,” indicating an aldehyde, “OH,” indicating an alcohol, and “Ac,” indicating an acetate. Also, the number of carbons in the chain can be indicated using numerals rather than using the written name. Thus, as used herein, an unsaturated carbon chain comprised of sixteen carbons can be written as hexadecene or 16.

As used herein, the term “isomer” refers to a molecule having the same chemical formula as another molecule, but with a different chemical structure. That is, isomers contain the same number of atoms of each element but have different arrangements of their atoms. Isomers include “structural isomers” and “stereoisomers.” In “structural isomers” (also referred to as “constitutional isomers”), the atoms have a different bond-sequence. Structural isomers have different IUPAC names and can include skeletal isomers, where hydrocarbon chains have variable amounts of branching, and positional isomers, which deals with the position of a functional group on a chain; and functional group isomerism, in which the molecular formula is the same but the functional group is different. The term “positional isomer” refers to a first compound which has the same carbon skeleton and functional group as a second compound but differs in the location of the functional group on or in the carbon skeleton. In stereoisomers, the bond structure is the same, but the geometrical positioning of atoms and functional groups in space differs. This class of isomers includes enantiomers, which are isomers that are non-superimposable mirror-images of each other, and diastereomers, which are stereoisomers that are not mirror-images. Geometric isomers or cis/trans isomers are diastereomers with a different stereochemical orientation at a bond. E/Z isomers, which are a subset of geometric isomers, are isomers with a different geometric arrangement at a double bond. Another type of isomer, conformational isomers (conformers), may be rotamers, diastereomers, or enantiomers depending on the exact compound.

An “effective amount” means that amount of a composition or component thereof that is sufficient to affect desired results. An effective amount can be administered in one or more administrations. For example, an effective amount of the composition can refer to an amount of a pheromone composition that is sufficient to attract a given insect to a given location. In some embodiments, an effective amount of the composition can refer to an amount that is sufficient to disrupt mating of a particular insect population of interest in a given locality.

The term “semiochemical” refers to a chemical substance emitted by one organism (emitter), detected by another organism (receiver) and affecting the behavior or physiology of the receiver. Semiochemicals can mediate either intra-specific (within a species) interactions (pheromones) or inter-specific (between species) interactions (allelochemicals). Chemicals that mediate intra-specific interactions or beneficial inter- specific interactions are referred to as chemical “signals”. A chemical that benefits the emitter or the receiver, but not both, is considered a “cue”.

Pheromones mediate intra-specific (within a species) interactions and include chemicals and blends of chemicals that mediate sexual interactions (sex pheromones), colony recognition in social insects (nestmate recognition pheromones), group cohesion (aggregation pheromones), trail following (trail pheromones), alarm signaling (alarm pheromones), and other within-species interactions.

The term “kairomone” refers to a chemical substance or blend emitted by one species and detected by another species, which benefits the receiver, and not the emitter. Kairomones include, for example, chemicals that are emitted by “hosts” (e.g., human, animals, plants, or fruit) and attract insects that feed on the host (e.g., mosquitoes that feed on human blood, herbivores that feed on plants, or fruit pests). Kairomones include, but are not limited to, compounds emitted by plants that attract insects, β-caryophyllene, iso-caryophyllene, α-humulene, inalool, Z3-hexenol/yl acetate, β-farnesene, benzaldehyde, phenylacetaldehyde, and combinations thereof.

As used herein, the term “pest” refers to any insect species that negatively impacts animals (e.g., humans or livestock animals) or plants, such as by competing for food with or feeding on humans and/or other animals, feeding on or otherwise damaging plants (e.g., feeding on and/or damaging agricultural or horticultural crops or plants, such as grains, bushes, trees, flowers, nuts, vegetables, or fruit), transmitting disease to animals or plants, damaging structures (e.g., houses or other buildings) or landscapes, or by causing annoyance or anxiety to humans and/or other animals.

The term “agricultural pest” as used herein refer to any insect species that causes damage to a plant species, typically an agricultural crop (i.e., a crop grown for human or animal consumption or other use).

The term “forest pest” as used herein refers to an insect species that causes harm to plants, trees, or forests.

The terms “urban pest” and “nuisance pest” refer to an insect species that infests or affects homes and/or other areas frequently occupied by humans.

The term “industrial pest” refers to insect species that cause damage at sites producing or storing goods for sale, e.g., wineries, distilleries, breweries, cotton-processing plants, food manufacturing and/or processing sites, etc.

The term “pest control agent” as used herein refers to compounds, organisms, or other agents that can be used to control or help to control a pest population. Pest control agents include attractants, such as pheromones, as well as chemical and biological agents that can kill pests, such as chemical insecticides and insecticidal microorganisms, e.g., bacteria (e.g., Bacillus thuringiensis), viruses, peptides (e.g., RNAi-based peptides), nucleic acids, fungi, etc. The term “killing agent” as used herein can refer to an agent (e.g., a chemical insecticide) that kills pests too rapidly for the pest to pass the agent on to another pest. Thus, killing agents include fast-acting insecticides, chemical agents that can kill insects within minutes or hours. However, killing agents are not limited to toxic chemicals. They also include agents that can be used to drown, suffocate, or electrocute insects.

The term “insecticide” as used herein refers to any compound that kills insects or insect pests. In some embodiments, the term insecticide refers to a chemical agent that kills insects or is toxic to insects.

The term “active compound” as used herein refers to a compound that attracts an insect, e.g., a sex pheromone, an aggregation pheromone, a kairomone, or a volatile compound in a food and/or fermentation-based attractant. The term “active agent” can be used synonomously with “active compound”. As described herein, in some embodiments, C7-C11 aldehydes (e.g., nonanal) can be used as active agents to attract insects. In some embodiments, 1-hexanol can be used as an active agent.

The term “active component”, as used herein refers to a composition comprising one or more active agents. In some embodiments of the presently disclosed subject matter, two or more active components can be used in combination to attract an insect. The individual active components can be provided in separate formulations or separate containers or the individual active components can be provided in a single formulation or container.

The term “lure” refers to a composition comprising an active compound that acts as an attractant.

The term “bait” refers to a composition comprising an active compound that acts as an attractant in mixture with a feeding stimulant.

The term “adhesive” as used herein refers to a compound or material that is sticky and to which insects will adhere. Non-limiting examples of adhesives include, but are not limited to glue, starch, honey, pectin, gluten, an adhesive tape, etc. The term “collectively” as used herein refers to the composition, properties or attributes of a plurality of individual parts or components when considered together or as a whole.

### II. GENERAL CONSIDERATIONS

Insects are attracted to chemical signals from potential mates by sex pheromones and from aggregation sites by aggregation pheromones. Insects are also attracted to host plants by plant-produced chemical cues (kairomones), and to other feeding sites, such as hosts for blood feeding, fruits, flowers, and fermentation media. Some feeding sites may also attract insects to lay eggs, whereas, in many other instances, insects are specifically attracted to chemical cues from egg laying sites. Many other chemical signals and cues from various sources attract various insects to various resources.

Recently, nonanal was determined to be a component of the sex pheromone of the fall armyworm (Spodoptera frugiperda) and to be able to synergize with existing pheromone blends to attract male FAW. See International Publication No. WO 2021/178948, the disclosure of which is incorporated herein by reference in its entirety. However, it was previously unknown if nonanal could also attract or synergize with pheromones to attract additional species. According to one aspect of the presently disclosed subject matter, and as described herein, it has now been found that nonanal can increase the effectiveness of previously described sex pheromone components (e.g. C14-C16 aldehydes, C14-C16 primary alcohols, or C14-C16 acetate esters, such as, but not limited to, (Z)-11-hexadecenal or (Z)-9-tetradecenal) of other genera of the Noctuidae family, including Helicoverpa species, such as Helicoverpa zea (also commonly known as corn earworm (CEW)), an agricultural pest with a large host range including corn and other crop plants, and Chloridea species, such as the tobacco budworm (Chloridea virescens, formerly known as Heliothis virescens), an agricultural pest with a large host range of field crops, including but not limited to, tobacco, cotton, soybean, as well as a wide variety of fruits, vegetables, and flowers. Accordingly, in some aspects, the presently disclosed subject matter relates to methods and compositions for attracting male insects of Helicoverpa, Heliothis, and Chloridea species, including, but not limited to, male corn earworms and male tobacco budworms.

Based on the finding that nonanal attracts male CEW in laboratory and field behavioral studies, and as described hereinbelow, a study of the female sex pheromone gland extract of Helicoverpa zea was performed using a gas chromatography-electroantennograom detector (GC-EAD), a device that couples a GC to an insect antenna, the olefactory organ of insects that serves as a biological detector. In this device, the GC separates chemicals in a mixture and presents them to the antenna, and its electrophysiological responses reveal which chemicals it senses. Through millions of years of evolution, the antenna has been tuned to species-specific pheromone components with sensitivity hundreds to thousands-fold greater than mass spectrometry (MS) detectors. Thus, GC-EAD can detect low-abundance sex pheromone compounds that more conventional GC-mass spectrometry (GC-MS)-based approaches for identifying sex pheromones can miss. Therefore, while not previously identified, nonanal (also known as nonanaldehyde, pelargonaldehyde, Aldehyde C9, or 9:Ald) was determined to be present in the sex pheromone gland of CEW and to elicit an EAD response in the antenna. Additionally, 1-hexanol was determined to be present in the sex pheromone gland of CEW and to elicit an EAD response in the antenna. 1-Hexanol has not been previously identified as a sex pheromone component of CEW or other similar moth species, such as other Helicoverpa species, or species of the closely related Heliothis and Chloridea genera. Behavioral studies under field conditions also indicated that 1-hexanol can improve insect attraction to commercial CEW lures, as well as further enhancing the effect of nonanal in combination with these lures. Thus, in some embodiments, the presently disclosed subject matter relates to methods and compositions for attracting male Helicoverpa, Heliothis, and Chloridea species that include 1-hexanol, either alone or with nonanal, and in combination with other, more traditional active components of the sex pheromone of these insects (e.g., C14-C16 aldehydes, C14-C16 primary alcohols and C14-C16 acetate esters).

As further described herein, it has also been found through laboratory and field behavior studies that nonanal can be used as a single active agent insect attractant or in combination with (e.g., along side or adjacent to) a second active agent that comprises one or more aggregation pheromone, kairomone, food attractant, and/or fermentation-based attractant (e.g., a vinegar (e.g., balsamic vinegar) or a microbial mixture). In some embodiments, the second active agent comprises a volatile agent. Thus, for example, nonanal can be used in baits and lures to attract various insects of both sexes, including the green June beetle (Cotinis nitida), an important agricultural pest of fruits, such as grapes, peaches, blackberries, blueberries, apples, and pears; and the vinegar fruit fly (Drosophila melanogaster), a nuisance/urban pest in food handling facilities, restaurants, hospitals, homes, etc., and an agricultural/industrial pest in vineyards, wineries, and distilleries. In some embodiments, the composition comprises about 0.1 weight (wt) % to about 100 wt % nonanal. In some embodiments, the composition comprises about 0.5 wt % to about 15wt % nonanal (e.g., about 0.5 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt % nonanal). In some embodiments, the composition comprises nonanal as a first active agent and further comprises a second active agent that comprises an aggregation pheromone, a kairomone, a food attractant, and/or a microbial agent. In some embodiments, the first active agent and the second active agent are formulated separately.

In some embodiments, nonanal and/or any other active agent of a composition to attract insects can be formulated for slow release. For instance, in some embodiments, nonanal can be formulated in an oil. In some embodiments, the oil is paraffin oil or another non-volatile and odorless oil. In some embodiments, the oil formulation of nonanal is placed in a dispenser or container protected from light. For instance, because of the high affinity of nonanal to paraffin oil, which is a mixture of alkanes, the emission of nonanal is reduced and prolonged.

In some embodiments, the presently disclosed subject matter provides a nonanal dispenser (or other C7-C11 aldehyde dispenser or a dispenser comprising a C7-C11 aldehyde (e g., nonanal) and a second active agent) comprising a glass (e.g., borosilicate) vial (e.g., a 2 mL vial) covered with aluminum foil or another material that can block sunlight. The vial can further contain deactivated glass wool (e.g., about 50 mg of deactivated glass wool) or another fiberous substrate (e.g., cellulose, wood, felt) The aluminum foil or other covering material can prevent the exposure of nonanal to sunlight, which can facilitate chemical reactions with environmental factors. The glass wool or other fiberous substrate can increase the surface of the nonanal solution and hold the solution in place inside the vial. Once the nonanal (or other C7-C11 aldehyde and/or other active agent) solution is loaded in the vial, the vial can be capped. For example, in some embodiments, the cap has a silicone septum with a PTFE liner through which a microcapillary glass is inserted (e.g., having a L: 1.25 inch; O.D.: 0.036 inch, I.D.: 0.017 inch; 5 μL internal volume) to allow the volatile nonanal to evaporate from the vial.

In some embodiments, the nonanal (or other C7-C11 aldehyde and/or other active agent) can be dissolved in a solvent or oil (e.g., hexanes) and placed in a polyethylene sleeve. The sleeve can be sealed and the nonanal (and/or another active agent) can slowly evaporate through the resulting bag (which can also be referred to as a “sachet”).

In some embodiments, the nonanal (or other C7-C11 aldehyde and/or other active agent) can be dissolved in a suitable solvent (e.g., DMSO) and used in combination with (e.g., along side of or adjacent to) a food and/or a fermentation-based attractant (e.g., balsamic vinegar) or a commercially available lure or bait. In some embodiments, the compositions described herein can be used in any trap commonly used to attract any insect species, e.g., an agricultural, forest, veterinary or medical, and/or urban pest insect species, such as, but not limited to common house flies (Musca domestica), fruit flies, Japanese beetles, Green June beetles, spotted wing Drosophila, and other insect pests. Such traps are well known to one skilled in the art and are commonly used in many states and countries in insect detection, monitoring, and eradication programs. Such traps can have any design, such as, but not limited to bucket-style traps (e.g., a Unitrap, available from Great Lakes IPM, Vestabury, Michigan, United States of America), sleeve-style traps, cone style traps (e.g., Hartstack traps), and sticky traps (e.g., plastic delta-shaped housings with sticky liners inserted therein). Additional types of traps are described, for example, in Cork (“A Pheromone Manual”, Natural Resources Institute, Chatham Maritime ME4 4TB, UK (2004)).

### III. COMPOSITIONS AND METHODS

In some embodiments, the presently disclosed subject matter provides a composition for attracting an insect, wherein the composition comprises a first active component, wherein said first active component comprises at least one C7-C11 aldehyde; and a second active component, wherein the second active compound comprises at least one of an aggregation pheromone, a kairomone, a food, and a fermentation-based attractant. Thus, in some embodiments, the first active component comprises at least compound from the group including, but not limited to heptanal, octanal, nonanal, decanal, and undecanal. In some embodiments, the first active component comprises or consists of nonanal. In some embodiments, the composition collectively comprises about 0.1 wt % to about 15 wt % nonanal (e.g., about 0.1 wt %, about 0.5 wt %, about 1 wt %, about 3 wt %, about 5 wt %, about 7 wt %, about 9 wt %, about 11 wt %, about 13 wt %, or about 15 wt % nonanal).

In some embodiments, the insect is a pest insect species. In some embodiments, the insect is an agricultural or forest pest. For example, in some embodiments, the insect is an agricultural pest and is a species of the genus Cotinis or Drosophila. In some embodiments, the Cotinis species is Cotinis nitida (commonly known as the Green June beetle). In some embodiments, the Drosophila species is Drosophila melanogaster (also known as the common fruit fly). However, the presently disclosed compositions can also be used to attract other Cotinis and Drosophila species. For example, the other Cotinis species include C. mutabilis (also known as the figeater beetle), C. aliena, C. antonii, C. barthelemyi, C. beraudi, C. boylei, C. columbica, C. fuscopicea, C. ibarrai, C. impia, C. laticornis, C. lebasi. C. lemoulti. C. olivia. C. orientalis. C. pauperula. C. polita. C. pokornyi. C. producta. C. pueblensis. C. punctatostriata, C. rufipennis. C. sinitoc. C. sphyracera. C. subviolacea, and C. viridicyanea. There are over a thousand other Drosophila species (e.g., other fruit or vinegar flies) including those of subgenera such as, but not limited to, Sophophora and Dorsilopha. In some embodiments, the other Drosophila species include, but are not limited to the group comprising D. suzukii (also known as the cherry vinegar fly or the spotted wing drophophila),D. simulans, D. sechellia, D. hydei, D. replete, and D. busckii.

In some embodiments, the insect is an urban pest. In some embodiments, the insect is a Musca species. In some embodiments, the insect is Musca domestica (also known as the common housefly). However, like the genus Drosophila, there are a large number of species of Musca. Thus, in some embodiments, the insect can be another species of Musca, such as, but not limited to, M. albia. M. autumnalis, M. osiris, M. sorbens, M. vetustissima, or M. vitripennis.

In some embodiments, the second active component comprises a fermentation-based attractant. In some embodiments, the fermentation-based attractant comprises or consists of a vinegar (e.g., balsamic vinegar) or a microbial mixture. In some embodiments, the second active component comprises or consists of 2-propanol. In some embodiments, the second active component comprises a commercially available fruit fly or house fly attractant or lure.

In some embodiments, the first active component and/or the second active component is formulated as a slow-release formulation. In some embodiments, the first active component is formulated as a slow-release formulation (e.g., an oil or an alkane, such as, but not limited to, paraffin oil).

In some embodiments, the composition further comprises an insect control agent, e.g., a killing agent, a slow-acting insecticide and/or a biological agent. Biological agents include, but are not limited to, bacteria, fungi, viruses, nucleic acids, peptides (e.g., RNAi-based peptides), and nematodes. In some embodiments, the insect control agent is a killing agent. In some embodiments, the killing agent is a fast-acting insecticide.

In some embodiments, the presently disclosed subject matter provides a method of attracting an insect, wherein the method comprises providing one or more baits or lures, wherein said one or more baits or lures comprise a single active component, wherein said single active component is a C7-C11 aldehyde. In some embodiments, the single active component (e.g., the C7-C11 aldehyde) is nonanal.

In some embodiments, the presently disclosed subject matter provides a method of attracting an insect, wherein the method comprising providing one or more baits or lures, wherein said one or more baits or lures collectively comprise (a) a first active component, wherein said first active component comprises at least one C7-C11 aldehyde; and (b) a second active component, wherein said second active component comprises at least one of an aggregation pheromone, a kairomone, a food, and a fermentation-based attractant. In some embodiments, the second active component can include two or more particular aggregration pheromones, kairomones, foods, and/or fermentation-based attractants. In some embodiment, the first active component comprises or consists of nonanal. In some embodiments, the first active component is nonanal.

In some embodiments, the insect is a pest. In some embodiments, the insect is an agricultural, forest, or urban pest. In some embodiments, the insect is an agricultural pest. In some embodiments, the agricultural pest is a Cotinis species or a Drosophila species. In some embodiments, the Continis species is Cotinis nitida. In some embodiments, the Drosophila species is Drosophila melanogaster. In some embodiments, the insect is an urban pest. In some embodiments, the insect is a Musca species. In some embodiments, the Musca species is Musca domestica.

In some embodiments, one or both of the first and the second active component is formulated as a slow-release formulation. In some embodiments, the first component is formulated as a slow-release formulation. In some embodiments, the first component is formulated in an oil or an alkane or another solvent such as DMSO.

In some embodiments, the second component comprises a fermentation-based attractant. In some embodiments, the second component comprises vinegar (e.g., balsamic vinegar) or 2-propanol (also known as isopropanol).

In some embodiments, one or more baits or lures are provided in association with a housing for trapping one or more insect. Thus, in some embodiments, the method further comprises trapping one or more insects. In some embodiments, the method further comprises transporting the trapped insects (e.g., to a different location where their presence would not cause potential harm or annoyance). In some embodiments, the one or more baits or lures further comprise a killing agent (e.g., a fast-acting insecticide) and the method further comprises killing one or more insect. Accordingly, in some embodiments, the method further comprises controlling and/or suppressing an insect population by treating attracted, optionally trapped insects, with an insect control agent, optionally a killing agent, such as a fast-acting insecticide. In some embodiments, the method is performed at or near a port of entry, such as, but not limited to at or near an imported container at a harbor, airport, roadway and/or train border crossing, to detect the presence or absence of an insect or to avoid accidental introduction of the insect into a new environment. In some embodiments, the method is performed in an agricultural or horticultural setting, e.g., a field or orchard, to avoid detruction of an agricultural crop. In some embodiments, the method is performed in an urban or suburban location, such as near or inside a residential building, restaurant, medical facility, office building, an airport, train station, bus station, subway station, or store. In some embodiments, the method can include estimating the size of an insect population based on analyzing the number of trapped insects.

In some embodiments, the presently disclosed subject matter provides a method of attracting a male insect of the genus Helicoverpa, Chloridea, or Heliothis. In some embodiments, the method comprises providing one or more baits or lures, wherein said one or more baits or lures collectively comprise: (a) a first active component, wherein said first active component comprises at least one C7-C11 aldehyde; and (b) a second active component, wherein said second active component comprises a sex pheromone (i.e., a previously reported sex pheromone) of said insect. In some embodiments, the male insect is a species of the genus Helicoverpa, such as, but not limited to, H. zea (also known as the corn earworm), H. armigera (also known as the cotton bollworm), H. assulta (also known as the oriental tobacco budworm), H. atacamae (also known as the Chilean corn earworm), H. fletcheri, H. gelotopoeon (also known as the South American bollworm),H. hardwicki, H. hawaiiensis (also known as the Hawaiian bud moth),H. helenae, H. pallida, H. prepodes, H. punctigera (also known as the Australian bollworm or the native budworm), H. titacacae, or H. toddi. In some embodiments, the male insect is a species of the genus Heliothis, such as, but not limited to, H. acesias, H. australis, H. borealis, H. belladonna, H. conifera, H. cystiphora, H. flavescens, H. flavigera, H. hoarei, H. lucilinea, H. maritima, H. metachrisea, H. melanoleuca, H. molochitina, H. nubigera (also known as the Eastern bordered straw moth), H. ononis, H. oregonica (also known as the Oregon gem), H. pauliani, H. peltigera (also known as the bordered straw),H. perstriata, H. philbyi, H. phloxiphaga, H. proruptus, H. punctifera (also known as the lesser budworm).H. roseivena, H. scutuligera, H. sturmhoefeli, H. viriplaca (also known as the marbled clover), H. virescens (now classified as Chloridea virescens, also known as the tobacco budworm), H. xanthia, H. xanthiata, as well as species of the subgenus Masalia (e.g., H. albida, H. albipuncta, etc.). Chloridea species include, but are not limited to, the group comprising C. virescens (also known as the tobacco budworm and formerly classified as Heliothis virescens), Chloridea subflexa (also known as the subflexus straw moth), and C. tergemina. In some embodiments, the male insect is a corn earworm) or a tobacco budworm.

In some embodiments, the first active component comprises or consists of nonanal. In some embodiments, the one or more baits or lures collectively comprise about 0.1% to about 10% of the first active component (on a weight to weight basis with the second active component or the main active agent (e.g., the main aldehyde active agent) of the second active component). Thus, in some embodiments, the one or more baits or lures collectively comprise about 0.1%, about 0.5%, about 1%, about 2%, about 3%, about 4%, about 5%, about 6%, about 7%, about 8%, about 9%, or about 10% of the first active component (e.g., nonanal) on a weight to weight basis with the second active component. In some embodiments, the second active component comprises one or more C14-C16 aldehyde, C14-C16 primary alcohol, or C14-C16 acetate ester. In some embodiments, the second active component comprises or consists of a C14 and/or a C16 aldehyde. In some embodiments, the second active component comprises or consists of one or both of (Z)-11-hexadecenal (Z11-16:Ald) and (Z)-9-tetradecenal (Z9-14:Ald).

In some embodiments, the first active component further comprises 1-hexanol as a second active agent of the first active component or further comprises 1-hexanol as an active agent in a third active component. In some embodiments, the first active component comprises or consists of 1-hexanol in place of the nonanal. Thus, in some embodiments, the first active component comprises a single active agent, i.e., 1-hexanol, and does not comprise nonanal. Accordingly, in some embodiments, the first active component (a) comprises (i) at least one C7-C11 aldehyde and/or (ii) 1-hexanol.

In some embodiments, the presently disclosed subject matter comprises method for attracting a male insect of the genus Helicoverpa, Chloridea, or Heliothis, wherein the method comprises providing one or more baits or lures, wherein said one or more baits or lures collectively comprise: (a) a first active component, wherein said first active component comprises 1-hexanol; and (b) a second active component, wherein said second active component comprises a sex pheromone (i.e., a previously reported sex pheromone) of said insect (e.g., at least one C14-C16 aldehyde, C14-C16 primary alcohol, or C14-C16 acetate ester). In some embodiments, the second active component comprises or consists of (Z)-11-hexadecenal and/or (Z)-9-tetradecenal. In some embodiments, the first active component further comprises nonanal. In some embodiments, the one or more baits or lures collectively comprise about 0.1% to about 10% of 1-hexanol (on a weight to weight basis with the second active component or the main active agent of the second active component (e.g., the main aldehyde of the second active component). Thus, in some embodiments, the one or more baits or lures collectively comprise about 0.1%, about 0.5%, about 1%, about 2%, about 3%, about 4%, about 5%, about 6%, about 7%, about 8%, about 9%, or about 10% of 1-hexanol on a weight to weight basis with the second active component.

The first and/or second components can include one or more additional components or carriers such as described hereinbelow. The first and second components can be formulated separately or together. In some embodiments, one or both of the first and the second active component is formulated in a slow-release formulation. In some embodiments, the first component is formulated a slow-release formulation. In some embodiments, the first component is formulated in an oil or an alkane or other solvent (e.g., DMSO).

In some embodiments, the one or more baits or lures are provided in association with a housing for trapping one or more insect. Thus, in some embodiments, the method further comprises trapping one or more insects. In some embodiments, the method further comprises transporting the trapped insects (e.g., to a different location where their presence would not cause damage to an agricultural or horticultural crop). In some embodiments, the one or more baits or lures further comprise a killing agent, a slow-acting insecticide or a biological agent) and the method further comprises killing one or more insect.

Accordingly, in some embodiments, the presently disclosed subject matter provides a method for controlling and/or suppressing a population of an agricultural pest, wherein the agricultural pest is a Helicoverpa, Chloridea, or Heliothis species. In some embodiments, the method comprises application of a composition comprising (or one or more baits and/or lures collectively comprising): (a) a first active component comprising at least one C7-C11 aldehyde (e.g., nonanal) and/or 1-hexanol; and (b) a second active component comprising a sex pheromone of said pest, such as at least one C14-C16 aldehyde, C14-C16 acetate ester, or C14-C16 primary alcohol. In some embodiments, the first active component comprises or consists of one or more C7-C11 aldehyde (e.g., nonanal). In some embodiments, the first active component comprises or consists of 1-hexanol. In some embodiments, the second active component comprises at least one of (Z)-11-hexadecenal and (Z)-9-tetradecenal. In some embodiments, the composition (or one or more baits or lures) is provided in association with a housing for trapping one or more pest and the method further comprises collecting one or more male agricultural pest of a Helicoverpa, Chloridea, or Heliothis species in the housing. In some embodiments, the method further comprises estimating a pest population size based upon analyzing the number of pests trapped in the housing. In some embodiments, the method further comprises keeping trapped male pests in said housing or transferring said trapped pests to another housing, thereby controlling a pest population by removing male pests from the total pest population and reducing the number of male pests available for mating. In some embodiments, the method further comprises controlling a pest population by treating attracted, optionally trapped, male pests with a slow-acting insecticide or biological control agent; and releasing the treated male pests, wherein the treated male pests transfer the slow-acting insecticide or biological control agent to female pests upon mating. In some embodiments, the method further comprises controlling a pest population by providing a plurality of the one or more baits or lures to a select location, thereby inundating the location with the first and second active components to confuse male agricultural pests and make it more difficult for said male agricultural pests to locate a mate. In some embodiments, the method further comprises controlling a pest population by treating the attracted, optionally trapped male pests with a killing agent, optionally a fast-acting insecticide. In some embodiments, the method is performed at or near a port of entrance, such as at or near an imported container at a harbor, airport, roadway and/or train border crossing, to detect the presence or absence of said pest.

In some embodiments, the method of controlling and/or suppressing the population of the agricultural pest comprises using one or more baits, lures, dispensers, traps, or multi-component devices to suppress mating of the agricultural pest of the Helicoverpa, Chloridea, or Heliothis species, wherein said one or more baits, lures, dispensers, traps, or multi-component devices collectively comprise a composition comprising: (a) a first active component comprising at least one C7-C11 aldehyde (e.g., nonanal) and/or 1-hexanol; and (b) a second active component comprising at least one sex pheromone of said pest, such as at least one C14-C16 aldehyde, C14-C16 acetate ester, or C14-C16 primary alcohol. In some embodiments, the first active component comprises or consists of one or more C7-C11 aldehyde. In some embodiments, the first active component comprises or consists of nonanal. In some embodiments, the first active component comprises or consists of 1-hexanol. In some embodiments, the second active component comprises at least one of (Z)-11-hexadecenal and (Z)-9-tetradecenal. In some embodiments, the method using one or more baits, lures, dispensers, traps, or multi-component devices comprises placing a plurality of said baits, lures, dispensers, traps or multicomponent devices in a location, optionally a field or orchard. The method of controlling and/or suppressing the population can be performed as part of a trapping, attract-and-kill, or mating disruption approach.

In some embodiments, the presently disclosed subject matter comprises a composition for attracting male insects of the genus Helicoverpa, Chloridea, or Heliothis, wherein the composition comprises (i) a first active component comprising 1-hexanol; and (ii) a second active component comprising a sex pheromone of the insect (e.g., at least one C14-C16 aldehyde, C14-C16 primary alcohol, or C14-C16 acetate ester). In some embodiments, the second active component comprises at least one of (Z)-11-hexadecenal and (Z)-9-tetradecenal. In some embodiments, the first active component further comprises nonanal. Thus, the first active component can comprise 1-hexanol or 1-hexanol and nonanal. The first and second active components can be separately formulated or formulated in a single formulation. In some embodiments, the first and/or second active component can be formulated in a slow-release formulation. In some embodiments, the composition further comprises an insect control agent (e.g., a killing agent, a slow-acting insecticide, or a biological agent).

In some embodiments, the presently disclosed subject matter comprises a composition for attracting male insects of the genus Helicoverpa, Chloridea, or Heliothis, wherein the composition comprises (i) a first active component comprising a C7-C11 aldehyde; and (ii) a second active component comprising a sex pheromone of the insect (e.g., at least one C14-C16 aldehyde, C14-C16 primary alcohol, or C14-C16 acetate ester). In some embodiments, the second active component comprises at least one of (Z)-11-hexadecenal and (Z)-9-tetradecenal. In some embodiments, the first active component comprises or consists of nonanal. The first and second active components can be separately formulated or formulated in a single formulation. In some embodiments, the first and/or second active component can be formulated in a slow-release formulation. In some embodiments, the composition further comprises an insect control agent (e.g., a killing agent, a slow-acting insecticide, or a biological agent).

### III. FORMULATIONS, CARRIERS, ADDITIONAL ACTIVE COMPONENTS, AND NON-ACTIVE COMPONENTS

In some embodiments, in any of the compositions or methods described above, the composition (or a formulation of one or more active component as described herein) can further include, in addition to one or more active agent, a carrier. The carrier can be, but is not limited to, an inert liquid or solid. Exemplary solid carriers include, but are not limited to, fillers such as kaolin, bentonite, dolomite, calcium carbonate, talc, powdered magnesia, Fuller's earth, wax, gypsum, diatomaceous earth, rubber, plastic, China clay, mineral earths such as silicas, silica gels, silicates, attaclay, limestone, chalk, loess, clay, dolomite, calcium sulfate, magnesium sulfate, magnesium oxide, ground synthetic materials, fertilizers such as ammonium sulfate, ammonium phosphate, ammonium nitrate, thiourea and urea, products of vegetable origin such as cereal meals, tree bark meal, wood meal and nutshell meal, cellulose powders, attapulgites, montmorillonites, mica, vermiculites, synthetic silicas and synthetic calcium silicates, or compositions of these. Exemplary liquid carriers include, but are not limited to, water; alcohols, such as ethanol, butanol or glycol, as well as their ethers or esters, such as methylglycol acetate; ketones, such as acetone, cyclohexanone, methylethyl ketone, methylisobutylketone, or isophorone; alkanes such as hexane, pentane, or heptanes; aromatic hydrocarbons, such as xylenes or alkyl naphthalenes; mineral or vegetable oils; aliphatic chlorinated hydrocarbons, such as trichloroethane or methylene chloride; aromatic chlorinated hydrocarbons, such as chlorobenzenes; water-soluble or strongly polar solvents such as dimethylformamide, dimethyl sulfoxide, or N-methylpyrrolidone; liquefied gases; waxes, such as beeswax, lanolin, shellac wax, carnauba wax, fruit wax (such as bayberry or sugar cane wax) candelilla wax, other waxes such as microcrystalline, ozocerite, ceresin, or montan; salts such as monoethanolamine salt, sodium sulfate, potassium sulfate, sodium chloride, potassium chloride, sodium acetate, ammonium hydrogen sulfate, ammonium chloride, ammonium acetate, ammonium formate, ammonium oxalate, ammonium carbonate, ammonium hydrogen carbonate, ammonium thiosulfate, ammonium hydrogen diphosphate, ammonium dihydrogen monophosphate, ammonium sodium hydrogen phosphate, ammonium thiocyanate, ammonium sulfamate or ammonium carbamateand mixtures thereof. Baits or feeding stimulants can also be added to the carrier.

In some embodiments, when a composition of the presently disclosed subject matter includes two or more active components or a method includes the use of two or more active components, the active components (e.g., the first active component and the second active component) are separately formulated. In some embodiments, the active components (e.g., the first active component and the second active component) are provided in the same formulation. Thus, in some embodiments, the active components (e.g., the first active component and the second active component) are provided in the same formulation and/or the same dispenser. In some embodiments, the active components (e.g., the first active component and the second active component) are provided in different formulations and/or in different dispensers.

In some embodiments, one or more of the active components (e.g., the first active component and/or the second active component) is formulated in a slow-release formulation, so as to provide slow release of the active component(s) into the atmosphere and/or so as to be protected from degradation following release. For example, a pheromone composition or individual components thereof can be formulated in carriers such as microcapsules, biodegradable flakes and paraffin wax-based matrices. Alternatively, a pheromone composition or individual components thereof can be formulated as a slow-release sprayable.

In some embodiments, the presently disclosed composition or an individual active component thereof can include one or more polymeric agents known to one skilled in the art. The polymeric agents can control the rate of release of the composition or active component to the environment. In some embodiments, the polymeric agent-containing composition is impervious to environmental conditions. The polymeric agent can also be a sustained-release agent that enables the composition to be released to the environment in a sustained manner. Examples of polymeric agents include, but are not limited to, celluloses, proteins such as casein, fluorocarbon-based polymers, hydrogenated rosins, lignins, melamine, polyurethanes, vinyl polymers such as polyvinyl acetate (PVAC), polycarbonates, polyvinylidene dinitrile, polyamides, polyvinyl alcohol (PVA), polyamide-aldehyde, polyvinyl aldehyde, polyesters, polyvinyl chloride (PVC), polyethylenes, polystyrenes, polyvinylidene, silicones, and combinations thereof. Examples of celluloses include, but are not limited to, methylcellulose, ethyl cellulose, cellulose acetate, cellulose acetate-butyrate, cellulose acetate-propionate, cellulose propionate, and combinations thereof. In some embodiments, the presently disclosed composition or individual active components thereof can be microencapsulated, in which small droplets of one or more active component are enclosed within polymer capsules. The capsules can control the release rate of the active component into the surrounding environment and can be small enough to be applied in the same method as used to spray insecticides. The effective field longevity of the microencapsulated formulations can range from a few days to more than a week, depending on climatic conditions, capsule size and chemical properties. Other agents which can be used in slow-release or sustained-release formulations include fatty acid esters (such as a sebacate, laurate, palmitate, stearate or arachidate ester) and fatty alcohols (such as undecanol, dodecanol, tridecanol, tridecenol, tetradecanol, tetradecenol, tetradecadienol, pentadecanol, pentadecenol, hexadecanol, hexadecenol, hexadecadienol, octadecenol and octadecadienol).

In some embodiments, composition of the presently disclosed subject matter (or a formulation comprising the first or second active component thereof, or a trap or multi-component device comprising the active components thereof) further comprises one or more additional active component, i.e., one or more non-attractant insect control agent, such as a killing agent, a slow-acting insecticide, or a biological agent. For example, the biological agent can be selected from a bacteria, a fungi, a virus, a nucleic acid, a peptide (e.g., a RNAi-based peptide), and a nematode. In some embodiments, the killing agent is a fast-acting insecticide. Examples of the chemical insecticides include, but are not limited to, Chemical insecticides include, but are not limited to, abamectin, AC 303 630, acephate, acrinathrin, alanycarb, aldicarb, alphamethrin, amitraz, avermectin, AZ 60541, azadirachtin, azinphos A, azinphos M, azocyclotin, bendiocarb, benfuracarb, bensultap, betacyfluthrin, bifenthrin, bioresmethrin, BPMC, brofenprox, bromophos A, bufencarb, buprofezin, butocarboxin, butylpyridaben, cadusafos, carbaryl, carbofuran, carbophenothion, carbosulfan, cartap, CGA 157 419, CGA 184699, chloethocarb, chlorethoxyfos, chlorfenvinphos, chlorfluazuron, chlormephos, chlorpyrifos, chlorpyrifos M, cis-Resmethrin, clocythrin, clofentezine, cyanophos, cycloprothrin, cyfluthrin, cyhalothrin, cyhexatin, cypermethrin, cyromazine, deltamethrin, demeton M, demeton S, demeton-S-methyl, diafenthiuron, diazinon, dichlofenthion, dichlorvos, dicliphos, dicrotophos, diethion, diflubenzuron, dimethoate, dimethylvinphos, dioxathion, disulfoton, edifenphos, emamectin, esfenvalerate, ethiofencarb, ethion, ethofenprox, ethoprophos, etrimphos, fenamiphos, fenazaquin, fenbutatin oxide, fenitrothion, fenobucarb, fenothiocarb, fenoxycarb, fenpropathrin, fenpyrad, fenpyroximate, fenthion, fenvalerate, fipronil, fluazinam, flucycloxuron, flucythrinate, flufenoxuron, flufenprox, fluvalinate, fonophos, formothion, fosthiazate, fubfenprox, furathiocarb, HCH, heptenophos, hexaflumuron, hexythiazox, imidacloprid, iprobenfos, isazophos, isofenphos, isoprocarb, isoxathion, ivermectin, lambda-cyhalothrin, lufenuron, malathion, mecarbam, mervinphos, mesulfenphos, metaldehyde, methacrifos, methamidophos, methidathion, methiocarb, methomyl, metolcarb, milbemectin, monocrotophos, moxidectin, naled, NC 184, NI 25, nitenpyram omethoat, oxamyl, oxydemethon M, oxydeprofos, parathion A, parathion M, permethrin, phenothrin, phenthoate, phorate, phosalone, phosmet, phosphamidon, phoxim, pirimicarb, pirimiphos M, pirimiphos A, profenofos, promecarb, propaphos, propoxur, prothiofos, prothoate, pymetrozin, pyrachlophos, pyridaphenthion, pyresmethrin, pyrethrum, pyridaben, pyrimidifen, pyriproxifen, quinalphos, resmethrin, RH 5992, salithion, sebufos, silafluofen, sulfotep, sulprofos, tebufenozid, tebufenpyrad, tebupirimiphos, teflubenzuron, tefluthrin, temephos, terbam, terbufos, tetrachlorvinphos, thiafenox, thiodicarb, thiofanox, thiomethon, thionazin, thuringiensin, tralocytrin, tralomethrin, triarathen, triazophos, triazuron, trichlorfon, triflumuron, trimethacarb, transfluthrin vamidothion, XMC, xylylcarb, and zetamethrin. Examples of the biological insecticides include, but are not limited to, azadirachtin (neem oil), toxins from natural pyrethrins, Bacillus thuringiencis and Beauveria bassiana, viruses, and peptides (e.g., RNAi-based peptides). In some embodiments, the killing agent is a fast-acting insecticide.

In some embodiments, the presently disclosed composition (or a formulation comprising an active component thereof) can further include one or more optional adjuvants and/or other compounds, provided that such optional adjuvants or other compounds do not substantially interfere with the activity of active components. In some embodiments, the optional adjuvants and/or other compounds can be selected from the group including, but not limited to: wetters, compatibilizing agents (also referred to as “compatibility agents”), antifoam agents, cleaning agents, sequestering agents, drift reduction agents, neutralizing agents and buffers, corrosion inhibitors, dyes, odorants, spreading agents (also referred to as “spreaders”), penetration aids (also referred to as “penetrants”), sticking agents (also referred to as “stickers” or “binders”), dispersing agents, fillers, thickening agents (also referred to as “thickeners”), stabilizers, emulsifiers, freezing point depressants, antimicrobial agents, and the like. Examples of stabilizers include, but are not limited to, fatty acids and vegetable oils, such as for example olive oil, soybean oil, corn oil, safflower oil, canola oil, and combinations thereof. Examples of fillers include, but are not limited to, one or more mineral clays (e.g., attapulgite). In some embodiments, the filler is an organic thickener. Examples of such thickeners include, but are not limited to, methyl cellulose, ethyl cellulose, and any combinations thereof.

In some embodiments, the composition (or a formulation comprising an active component) can include one or more solvents. Compositions containing solvents are desirable when a user is to employ liquid compositions which can be applied by brushing, dipping, rolling, spraying, or otherwise applying the liquid compositions to substrates on which the user wishes to provide a semiochemical coating (e.g., a lure). In some embodiments, the solvent(s) to be used is/are selected so as to solubilize, or substantially solubilize, the one or more ingredients (e.g., one or more active components, or individual compounds thereof) of the composition. Examples of solvents include, but are not limited to, water, aqueous solvent (e.g., mixture of water and ethanol), ethanol, methanol, chlorinated hydrocarbons, petroleum solvents, turpentine, xylene, and any combinations thereof.

In some embodiments, the presently disclosed composition (or a formulation comprising an active component thereof) can comprise one or more organic solvents. Organic solvents can be used, for example, in the formulation of emulsifiable concentrates, ULV formulations, and to a lesser extent granular formulations. Sometimes mixtures of solvents are used. In some embodiments, the organic solvents can include aliphatic paraffinic oils such as kerosene or refined paraffins. In come embodiments, the organic solvents can comprise an aromatic solvent such as xylene and higher molecular weight fractions of C9 and C10 aromatic solvents. In some embodiments, chlorinated hydrocarbons are useful as co-solvents to prevent crystallization when the formulation is emulsified into water.

In some embodiments, the presently disclosed composition (or a formulation comprising an active component thereof) can comprise one or more solubilizing agents. Solubilizing agents include surfactants, which can form micelles in water at concentrations above the critical micelle concentration. The micelles are then able to dissolve or solubilize water-insoluble materials inside the hydrophobic part of the micelles. In some embodiments, the surfactants are non-ionics, e.g., sorbitan monooleates; sorbitan monooleate ethoxylates; and methyl oleate esters.

In some embodiments, the presently disclosed compositions (or a formulation comprising an active component thereof) can comprise one or more binders. Binders can be used to promote association of a composition with the surface of the material on which said composition is coated. In some embodiments, the binder can be used to promote association of another additive (e.g., insecticide, insect growth regulators, and the like) to an active component (e.g., a first and/or second active component) of the composition and/or the surface of a material. For example, a binder can include a synthetic or natural resin typically used in paints and coatings. These can be modified to cause the coated surface to be friable enough to allow insects to bite off and ingest the components of the composition (e.g., insecticide, insect growth regulators, and the like), while still maintaining the structural integrity of the coating.

Non-limiting examples of binders include polyvinylpyrrolidone, polyvinyl alcohol, partially hydrolyzed polyvinyl acetate, carboxymethylcellulose, starch, vinylpyrrolidone/vinyl acetate copolymers and polyvinyl acetate, or compositions of these; lubricants such as magnesium stearate, sodium stearate, talc or polyethylene glycol, or compositions of these; antifoams such as silicone emulsions, long-chain alcohols, phosphoric esters, acetylene diols, fatty acids or organofluorine compounds, and complexing agents such as: salts of ethylenediaminetetraacetic acid (EDTA), salts of trinitrilotriacetic acid or salts of polyphosphoric acids, or compositions of these. In some embodiments, the binder also acts a filler and/or a thickener. Examples of such binders include, but are not limited to, one or more of shellac, acrylics, epoxies, alkyds, polyurethanes, linseed oil, tung oil, and any combinations thereof.

In some embodiments, the presently disclosed composition (or a formulation comprising an active component thereof) can comprise one or more surface-active agents. In some embodiments, the surface-active agents are added to a liquid composition of the presently disclosed subject matter. In some embodiments, the surface-active agents are added to solid formulations, e.g., those designed to be diluted with a carrier before application. Thus, in some embodiments, the presently disclosed composition comprises one or more surfactants. Surfactants are sometimes used, either alone or with other additives, such as mineral or vegetable oils as adjuvants to spray-tank mixes to improve the biological performance of the composition on the target. The surface-active agents can be anionic, cationic, or nonionic in character, and can be employed as emulsifying agents, wetting agents, suspending agents, or for other purposes. In some embodiments, the surfactants are non-ionics such as: alky ethoxylates, linear aliphatic alcohol ethoxylates, and aliphatic amine ethoxylates. In some embodiments, the surfactants can include alkali metal, alkaline earth metal or ammonium salts of aromatic sulfonic acids, for example, ligno-, phenol-, naphthalene-and dibutylnaphthalenesulfonic acid, and of fatty acids of arylsulfonates, of alkyl ethers, of lauryl ethers, of fatty alcohol sulfates and of fatty alcohol glycol ether sulfates, condensates of sulfonated naphthalene and its derivatives with formaldehyde, condensates of naphthalene or of the naphthalenesulfonic acids with phenol and formaldehyde, condensates of phenol or phenolsulfonic acid with formaldehyde, condensates of phenol with formaldehyde and sodium sulfite, polyoxyethylene octylphenyl ether, ethoxylated isooctyl-, octyl- or nonylphenol, tributylphenyl polyglycol ether, alkylaryl polyether alcohols, isotridecyl alcohol, ethoxylated castor oil, ethoxylated triarylphenols, salts of phosphated triarylphenolethoxylates, lauryl alcohol polyglycol ether acetate, sorbitol esters, lignin-sulfite waste liquors or methylcellulose, or compositions of these.

In some embodiments, the surface-active agent(s) can include salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C18 ethoxylate; alcohol-alkylene oxide addition products, such as tridecyl alcohol-C16 ethoxylate; soaps, such as sodium stearate; alkylnaphthalene-sulfonate salts, such as sodium dibutyl-naphthalenesulfonate; dialkyl esters of sulfosuccinate salts, such as sodium di(2-ethylhexyl)sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, particularly methyl esters.

In some embodiments, a composition of the presently disclosed subject matter (or a formulation comprising an active component thereof) can comprise one or more wetting agents. A wetting agent is a substance that when added to a liquid increases the spreading or penetration power of the liquid by reducing the interfacial tension between the liquid and the surface on which it is spreading. Wetting agents can be used in agrochemical formulations during processing and manufacture to increase the rate of wetting of powders in water to make concentrates for soluble liquids or suspension concentrates; and/or during mixing of a product with water in a spray tank or other vessel to reduce the wetting time of wettable powders and to improve the penetration of water into water-dispersible granules. In some embodiments, examples of wetting agents used in the presently disclosed composition (or a component thereof), include wettable powders, suspension concentrates, and water-dispersible granule formulations are: sodium lauryl sulphate; sodium dioctyl sulphosuccinate; alkyl phenol ethoxylates; and aliphatic alcohol ethoxylates.

In some embodiments, a composition of the presently disclosed subject matter (or a formulation comprising an active component thereof) comprises one or more dispersing agents. A dispersing agent is a substance which adsorbs onto the surface of particles and helps to preserve the state of dispersion of the particles and prevents them from reaggregating. In some embodiments, dispersing agents are added to a composition of the presently disclosed subject matter to facilitate dispersion and suspension during manufacture, and to ensure the particles redisperse into water in a spray tank. In some embodiments, dispersing agents are used in wettable powders, suspension concentrates, and water-dispersible granules. Surfactants that are used as dispersing agents have the ability to adsorb strongly onto a particle surface and provide a charged or steric barrier to re-aggregation of particles. In some embodiments, the surfactants are anionic, non-ionic, or mixtures of the two types.

In some embodiments, for wettable powder formulations, the dispersing agents comprise one or more sodium lignosulphonates. In some embodiments, suspension concentrates provide good adsorption and stabilization using polyelectrolytes, such as sodium naphthalene sulphonate formaldehyde condensates. In some embodiments, tristyrylphenol ethoxylated phosphate esters are used. In some embodiments, alkylarylethylene oxide condensates and EO-PO block copolymers are combined with anionics as dispersing agents for suspension concentrates.

In some embodiments, the presently disclosed compositions (or a formulation comprising an active component thereof) can comprise one or more polymeric surfactants. In some embodiments, the polymeric surfactants have very long hydrophobic ‘backbones’ and a large number of ethylene oxide chains forming the ‘teeth’ of a ‘comb’ surfactant. In some embodiments, these high molecular weight polymers can give good long-term stability to suspension concentrates, because the hydrophobic backbones have many anchoring points onto the particle surfaces. In some embodiments, the dispersing agents are selected from: sodium lignosulphonates; sodium naphthalene sulphonate formaldehyde condensates; tristyrylphenol ethoxylate phosphate esters; aliphatic alcohol ethoxylates; alky ethoxylates; EO-PO block copolymers; and graft copolymers.

In some embodiments, the presently disclosed compositions (or a formulation comprising an active component thereof) can comprise one or more emulsifying agents. An emulsifying agent is a substance, which stabilizes a suspension of droplets of one liquid phase in another liquid phase. Without the emulsifying agent the two liquids would separate into two immiscible liquid phases. In some embodiments, the emulsifier comprises an alkylphenol or aliphatic alcohol with about 12 or more ethylene oxide units and the oil- soluble calcium salt of dodecylbenzene sulphonic acid. A range of hydrophile-lipophile balance (“HLB”) values from 8 to 18 can normally provide good stable emulsions. In some embodiments, emulsion stability can sometimes be improved by the addition of a small amount of an EO-PO block copolymer surfactant.

In some embodiments, the presently disclosed compositions (or a formulation comprising an active component thereof) can comprise one or more gelling agents. Thickeners or gelling agents can be used in the formulation of suspension concentrates, emulsions, and suspoemulsions to modify the rheology or flow properties of the liquid and to prevent separation and settling of the dispersed particles or droplets. Thickening, gelling, and anti-settling agents generally can fall into two categories: water-insoluble particulates and water-soluble polymers. It is possible to produce suspension concentrate formulations using clays and silicas. In some embodiments, the presently disclosed compositions comprise one or more thickeners including, but not limited to: montmorillonite, e.g. bentonite; magnesium aluminum silicate; and attapulgite. In some embodiments, a polysaccharide can be used as a thickening agent. The types of polysaccharides typically used as thickening agents are natural extracts of seeds and seaweeds or synthetic derivatives of cellulose. In some embodiments the thickening agent comprises xanthan and/or cellulose. In some embodiments, the thickening agents can be selected from the group including, but not limited to, guar gum; locust bean gum; carrageenam; alginates; methyl cellulose; sodium carboxymethyl cellulose (SCMC); hydroxyethyl cellulose (HEC). In some embodiments, the compositions of the presently disclosed subject matter can include one or more other types of anti-settling agents, such as modified starches, polyacrylates, polyvinyl alcohol, xanthan gum, and polyethylene oxide.

In some embodiments, the presence of surfactants, which lower interfacial tension, can cause water-based formulations to foam during mixing operations in production and in application through a spray tank. Thus, in some embodiments, in order to reduce the tendency to foam, anti-foam agents are often added either during the production stage or before filling into bottles/spray tanks. Generally, there are two types of anti-foam agents, silicones and nonsilicones. Silicones are usually aqueous emulsions of dimethyl polysiloxane, while the nonsilicone anti-foam agents are water-insoluble oils, such as octanol and nonanol, or silica. In both cases, the function of the anti-foam agent is to displace the surfactant from the air-water interface.

In some embodiments, the presently disclosed composition (or a formulation comprising an active component thereof) can comprise a preservative.

In some embodiments, the composition of the presently disclosed subject matter (or a formulation comprising an active component thereof) can include one or more insect feeding stimulants. Examples of insect feeding stimulants include, but are not limited to, crude cottonseed oil, fatty acid esters of phytol, acetic acid (vinegar) or another chemical emitted by rotting fruit, fatty acid esters of geranyl geraniol, fatty acid esters of other plant alcohols, plant extracts, and combinations thereof.

In some embodiments, the composition (or formulation comprising an active component thereof) can include one or more insect growth regulators (“IGRs”). IGRs can be used to alter the growth of the insect and produce deformed insects. Examples of insect growth regulators include, for example, dimilin. In some embodiments, the composition can include one or more insect sterilants that sterilize trapped insects or otherwise block their reproductive capacity, thereby reducing the population in the following generation. In some embodiments, allowing the sterilized insects to survive and compete with non-trapped insects for mates is more effective than killing them outright.

In some embodiments, the compositions disclosed herein (or one of the active components thereof) can be formulated as a sprayable composition (i.e., a sprayable pheromone composition). An aqueous solvent can be used in the sprayable composition, e.g., water or a mixture of water and an alcohol (e.g., ethanol), glycol, ketone, or other water-miscible solvent. In some embodiments, the water content of such mixture is at least about 10%, at least about 20%, at least about 30%, at least about 40%, 50%, at least about 60%, at least about 70%, at least about 80%, or at least about 90%. In some embodiments, the sprayable composition is a concentrate, i.e. a concentrated suspension of the first and/or second active component(s), and other additives (e.g., a waxy substance, a stabilizer, and the like) in the aqueous solvent, and can be diluted to the final use concentration by addition of solvent (e.g., water).

In some embodiments, a waxy substance can be used as a carrier for an active component (e.g., the first and/or second active component) in the sprayable composition. The waxy substance can be, e.g., a biodegradable wax, such as bees wax, carnauba wax and the like, candelilla wax (hydrocarbon wax), montan wax, shellac and similar waxes, saturated or unsaturated fatty acids, such as lauric, palmitic, oleic or stearic acid, fatty acid amides and esters, hydroxylic fatty acid esters, such as hydroxyethyl or hydroxypropyl fatty acid esters, fatty alcohols, and low molecular weight polyesters such as polyalkylene succinates.

In some embodiments, a stabilizer can be used with the sprayable compositions. The stabilizer can be used to regulate the particle size of concentrate and/or to allow the preparation of a stable suspension of the composition. In some embodiments, the stabilizer is selected from hydroxylic and/or ethoxylated polymers. Examples include ethylene oxide and propylene oxide copolymer, polyalcohols, including starch, maltodextrin and other soluble carbohydrates or their ethers or esters, cellulose ethers, gelatin, polyacrylic acid and salts and partial esters thereof and the like. In other embodiments, the stabilizer can include polyvinyl alcohols and copolymers thereof, such as partly hydrolyzed polyvinyl acetate. The stabilizer may be used at a level sufficient to regulate particle size and/or to prepare a stable suspension, e.g., between 0.1% and 15% of the aqueous solution.

In some embodiments, a binder can be used with the sprayable compositions. In some embodiments, the binder can act to further stabilize the dispersion and/or improve the adhesion of the sprayed dispersion to the target locus (e.g., a trap, lure, plant, etc.). The binder can be a polysaccharide, such as an alginate, cellulose derivative (acetate, alkyl, carboxymethyl, hydroxyalkyl), starch or starch derivative, dextrin, gum (arabic, guar, locust bean, tragacanth, carrageenan, and the like), sucrose, and the like. The binder can also be a non-carbohydrate, water-soluble polymer such as polyvinyl pyrrolidone, or an acidic polymer such as polyacrylic acid or polymethacrylic acid, in acid and/or salt form, or mixtures of such polymers.

In some embodiments, the presently disclosed composition (or a formulation of an active component thereof) can be used in conjunction with a dispenser for release of the composition or the individual active components in a particular environment. Any suitable dispenser known in the art can be used. Examples of such dispensers include but are not limited to, aerosol emitters, hand-applied dispensers, vials or bubble caps comprising a reservoir with a permeable cap or barrier through which semiochemicals are slowly released, pads, beads, tubes rods, spirals or balls composed of rubber, plastic, leather, cotton, cotton wool, wood or wood products that are impregnated with the composition. For example, polyvinyl chloride laminates, pellets, granules, ropes or spirals from which the composition evaporates, or rubber septa. One of skill in the art will be able to select suitable carriers and/or dispensers for the desired mode of application, storage, transport or handling.

Accordingly, in some embodiments, the composition of the presently disclosed subject matter (or a formulation of an active component thereof) can be coated on or sprayed on a solid substrate that can be used as a dispenser comprising, for example, a polymer, a glass, a rubber, an elastomer, cellulose, wood, and felt, or the substrate can be otherwise impregnated with a composition of the presently disclosed subject matter or an active component thereof (e.g., a first or second active component thereof).

### V. TRAPS AND OTHER DEVICES

As described hereinabove, in some embodiments, the presently disclosed subject matter comprises the deployment of traps with synthetic lures that mimic a Helicoverpa, Heliothis, or Chloridea species (e.g., a corn earworm or tobacco budworm) sex pheromone to provide an approach to detect new agricultural insect pest infestations at early stages, monitor established infestations, and control resurgent pest populations. Sex pheromones are good attractants for pest management because males are highly mobile and respond to extremely low amounts of highly species-specific sex pheromone. In addition, they reliably predict when adult insect pests fly and adult insects are much more accessible and susceptible to insecticide and biocide treatments than are larval stages. Further, at high doses, sex pheromones are effective at suppressing mating, a process called ‘mating disruption’, that effectively controls pest populations with minimal inputs.

In some embodiments, the presently disclosed subject matter comprises the deployment of traps with lures that contain or mimic kairomones, food attractants, and/or egg laying attractants. These traps can be used to attract a variety of insects, such as, but not limited to, fruit flies, Japanese beetles, and common house flies (e.g., species of a genus selected from Cotinis, Drosophila and Musca).

Accordingly, in some embodiments, the composition (or lures or dispensers comprising one or more components of the presently disclosed composition) can be incorporated into a trap or multi-component device, comprising a housing for trapping insects or insect pests. In some embodiments, the presently disclosed composition can be used in a trap commonly used to attract any insect species. Such traps are well known to one skilled in the art and are commonly used in many states and countries in insect detection, monitoring, and eradication programs. Such traps can have any design, such as, but not limited to bucket-style traps (e.g., a Unitrap, available from Great Lakes IPM, Vestabury, Michigan, United States of America), sleeve-style traps, cone style traps (e.g., Hartstack traps), and sticky traps (e.g., plastic delta-shaped housings with sticky liners inserted therein).

In some embodiments, the trap includes one or more septa, containers, or storage receptacles for holding the composition. Thus, in some embodiments, the presently disclosed subject matter provides a trap loaded with a composition of the presently disclosed subject matter. The traps can be used, for example, to attract insects as part of a strategy for insect monitoring, mass trapping, mating disruption, or lure/attract and kill for example by incorporating a toxic substance into the trap to kill insects caught.

Mass trapping can involve placing a high density of traps in a crop to be protected so that a high proportion of the insects are removed before the crop is damaged. Lure/attract-and-kill techniques are similar except once the insect is attracted to a lure, it is subjected to a killing agent. Where the killing agent is an insecticide, a dispenser can also contain a bait or feeding stimulant that can entice the insects to ingest an effective amount of an insecticide. The insecticide can be an insecticide known to one skilled in the art. The insecticide can be mixed with the composition of the presently disclosed subject matter (or a single component thereof) or be separately present in a trap. Such traps can take any suitable form, and killing traps need not necessarily incorporate toxic substances, the insects being optionally killed by other means, such as drowning or electrocution. Alternatively, the traps can contaminate the insect with a fungus or virus that kills the insect later. Even where the insects are not killed, the trap can serve to remove the male insects (pheromones) or both sexes (kairomones) from a locale, e.g., to prevent breeding and pest damage.

In some embodiments, the trap is selected from the group including, but not limited to, water traps, sticky traps, and one-way traps. Sticky traps come in many varieties. One example of a sticky trap is of cardboard construction, triangular or wedge-shaped in cross- section, where the interior surfaces are coated with a non-drying sticky substance. The insects contact the sticky surface and are caught. Water traps include pans of water and detergent that are used to trap insects. The detergent destroys the surface tension of the water, causing insects that are attracted to the pan, to drown in the water. One-way traps allow an insect to enter the trap but prevent it from exiting. In some embodiments, the traps can be colored brightly, to provide additional attraction for the insects.

In some embodiments, the traps containing the presently disclosed composition can be combined with other kinds of trapping mechanisms. For example, in addition to the presently disclosed composition, the trap can include one or more fluorescent lights, one or more sticky substrates and/or one or more colored surfaces for attracting insects. In other embodiments, the trap containing the presently disclosed composition does not have other kinds of trapping mechanisms.

The trap can be set at any time of the year in a field. Those of skill in the art can readily determine an appropriate amount of the compositions to use in a particular trap and can also determine an appropriate density of traps/acre of crop field to be protected. The trap can be positioned in an area infested (or potentially infested) with insects. In some embodiments, the trap is placed on or close to a tree or plant. The aroma of the active ingredients in the presently disclosed composition (e.g., the first and/or second active components) can attract the insects to the trap. The insects can then be caught, immobilized and/or killed within the trap, for example, by a killing agent present in the trap.

The traps can be provided in made-up form, where the presently disclosed composition has already been applied. In such an instance, depending on the half-life of the active components in the composition, the active components can be exposed or can be sealed in a conventional manner, such as is standard with other aromatic dispensers, the seal only being removed once the trap is in place. Alternatively, the trap can be provided separately from the composition and the composition can be provided in a dispensable format so that an amount can be applied to trap, once the trap is in place. In some embodiments, the presently disclosed composition can be provided in a sachet or other dispenser or a kit comprising a sachet or other dispenser for each of the two active components.

In some embodiments, the housing further comprises a mount (e.g., a bracket and/or fastening mechanism) or hanger configured to mount or hang the device in a fixed location. In some embodiments, the housing further comprises an insert comprising an adhesive that can adhere to said pest to keep said pest from exiting the housing.

In some embodiments, the device comprises a further active agent. In some embodiments, the further active agent comprises a killing agent, a slow-acting insecticide, or a biological agent. In some embodiments, the biological agent is selected from the group comprising a bacteria, a virus, a fungi, a nucleic acid, a peptide (e.g., a RNAi-based peptide) and a nematode.

Accordingly, in some embodiments, the presently disclosed subject matter provides a multi-component device for attracting and capturing an insect, the device comprising: (a) a first active component comprising at least one C7-C11 aldehyde (e.g., nonanal); (b) a second active component comprising either (i) a sex pheromone of a Helicoverpa, Heliothis, or Chloridea species (i.e., a known sex pheromomone of said species, such as at least one C14-C16 aldehyde, C14-C16 acetate ester, or C14-C16 primary alcohol or (ii) one or more of an aggregation pheromone, a kairomone, a food, and a fermentation-based attractant; (c) a housing comprising one or more opening for entry of said insect, optionally wherein said housing further comprises a mount configured to mount the device in a fixed position; and (d) one or more dispensers, wherein first active component (a) is incorporated into at least one of said one or more dispensers and wherein second active component (b) is incorporated into at least one of said one or more dispensers. In some embodiments, the second active component is an aggregation pheromone, a kairomone, a food, or a fermentation-based attractant (e.g., vinegar). In some embodiments, the second active component comprises or consists of (Z)-11-hexadecenal and/or (Z)-9-tetradecenal. In some embodiments, the first active component comprises or consists of nonanal. In some embodiments, when the second active component comprise a sex pheromone of a Helicoverpa, Heliothis, or Chloridea species, the first active component further comprises 1-hexanol (or can comprise or consist of 1-hexanol in place of the one or more C7-C11 aldehyde. In some embodiments, at least one of said one or more dispensers is made of a chemically neutral material selected from the group comprising a polymer, a glass, a rubber, an elastomer, cellulose, wood, and felt. In some embodiments, the housing further comprises an insert comprising an adhesive that can adhere to said pest to keep said pest from exiting the housing. In some embodiments, the device further comprises a further active agent comprising a killing agent, a slow-acting insecticide, or a biological agent, optionally wherein said biological agent is selected from the group comprising a bacteria, a virus, a fungi, a peptide (e.g., a RNAi-based peptide), a nucleic acid, and a nematode.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Example 1

### Corn Earworm

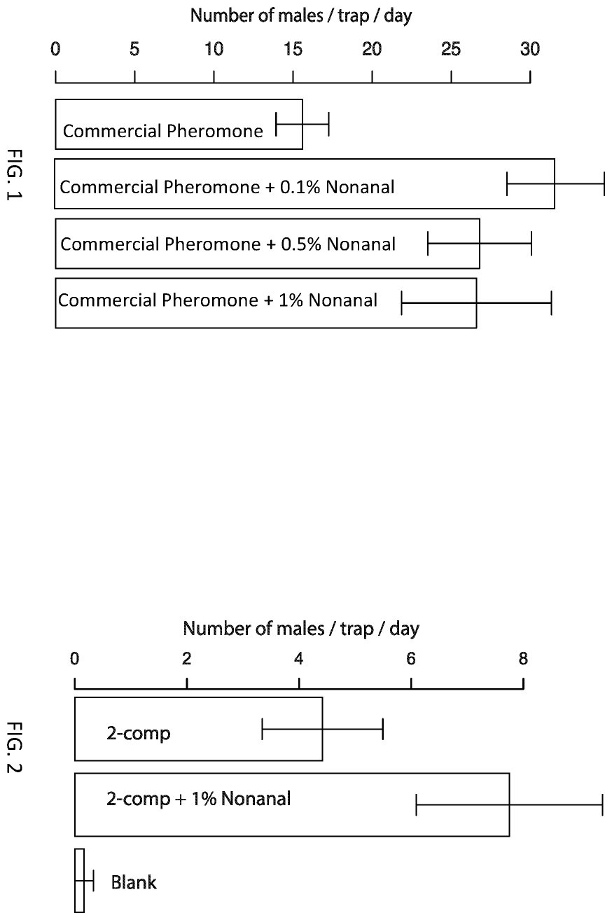

Nonanal was used in combination with a commercially available sex pheromone lure for trapping male corn earworms. More particularly, assuming that the commercial pheromone lure contained about 2 mg of the major component ((Z)-11-hexadecenal), various amounts (0.1%, 0.5%, or 1%) of nonanal on a weight to weight basis were loaded in paraffin oil in a separate dispenser (e.g., equipped with a microcapillary for emission of the nonanal) and placed adjacent to commercially available lures (TC/CO-3138-25, Trece Incorporated, Adair, Oklahoma, United States of America) in a Hartstack trap. FIG. 1 shows the number of male corn earworms caught per trap per day with the different lures (Trece+0.1% nonanal, Trece+0.5% nonanal, and Trece+1% nonanal). For comparison, the number of corn earworms caught in traps only containing the commercial lures (Trece) were also counted (N=10).

### Example 2

### Tobacco Budworm

Nonanal was used in combination with a 2-component sex pheromone blend (2-comp: 300 μg (Z)-11-hexadecenal and 15 μg (Z)-9-tetradecenal) for trapping male tobacco budworms. The two-component sex pheromone blend was loaded into a lure and 1% (weight to weight, relative to 300 μg (Z)-11-hexadecenal) nonanal was loaded in a separate lure and placed adjacent to the two-component sex pheromone lure (2-comp+1% nonanal) in Hartstack traps. The two-component sex pheromone blend in 0.1 ml hexane was loaded in a red rubber septum (11 mm; WHEATON®, DWK Life Sciences, Millville, New Jersey, United States of America). Nonanal was loaded in paraffin oil into a separate glass vial. For comparison, Hartstack traps with only the 2-component sex pheromone blend (2-comp) were also used. FIG. 2 shows the number of male tobacco budworms caught per trap per day (N=12). Data is also shown for blank traps (N=6).

### Example 3

### Green June Beetle

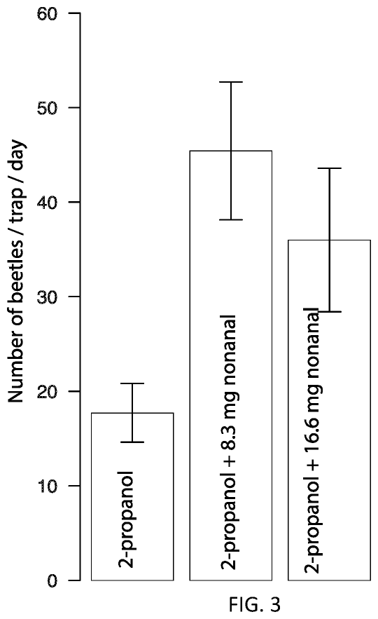

Nonanal was used in combination with lures prepared using 2-propanol (CAS #67-63-0, Thermo Fisher Scientific, Waltham, Massachusetts, United States of America) as an active agent for trapping green June beetles. Bucket Traps (GL/IP-2352-25, Great Lakes IPM, Vestaburg, Michigan, United States of America) were set up comprising only 2-propanol lures (2-propanol), lures comprising 2-propanol and 8.3 mg nonanal (2-propanol+8.3 mg nonanal), and lures comprising 2-propanol and 16.6 mg nonanal (2-propanol+16.6 mg nonanal). Nonanal was placed in a glass vial, separately from 2-propanol, but adjacent to it. FIG. 3 shows the number of male and female green June beetles caught per trap per day (N=7).

### Example 4

### Fruit Fly

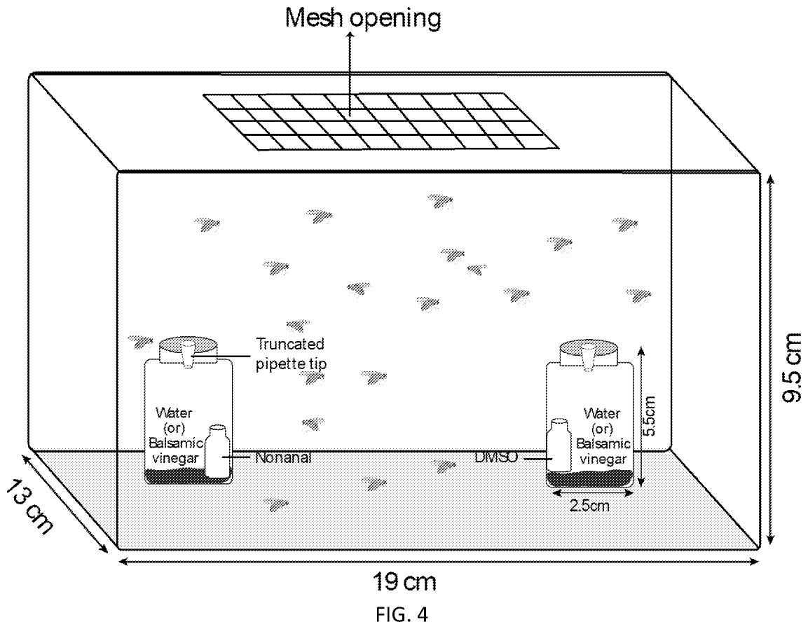

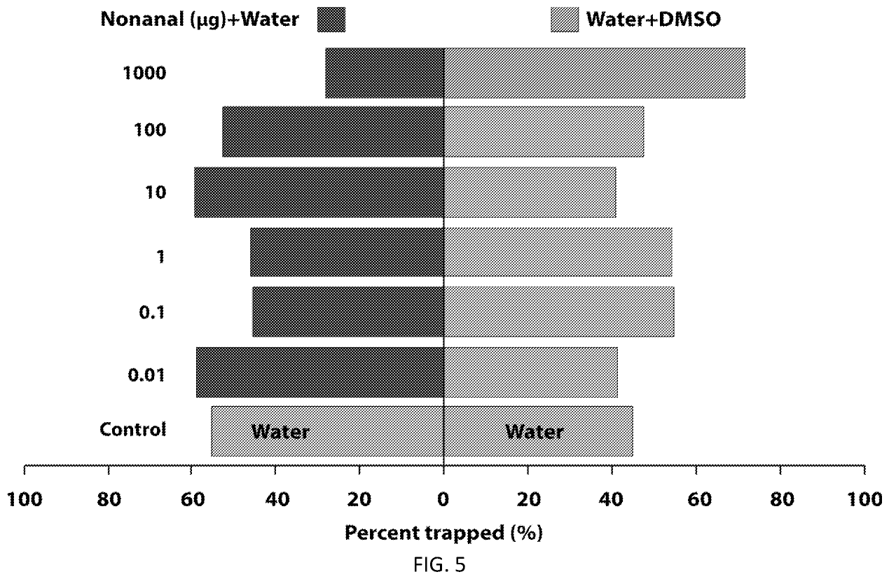

The attraction of starved Drosphila melanogaster males and females to balsamic vinegar (Bellino, Cento Fine Foods, Deptford, New Jersey, United States of America) with and without 1 μg nonanal was studied in a dual choice trapping assay. Nonanal was placed in a glass vial, separately from the balsamic vinegar, but adjacent to it. In all experiments, 20 3-4 day old, 24 hours starved flies (males and females) were given a choice between two traps. See FIG. 4, which shows a schematic diagram of the dual-choice trapping device. After 24 hours, flies in both traps were counted.

### Example 5

### Fruit Fly

The attraction of starved Drosphila melanogaster males and females to nonanal alone in various amounts is shown in FIG. 5. The experiment was conducted using the same methodology as shown in FIG. 4. Various amounts of nonanal were dissolved in DMSO, and then 10 μl of nonanal DMSO solution were placed in a separate glass vial (12×32 mm, Thermo Fisher Scientific. Waltham, Massachusetts, United States of America) adjacent to 0.4 ml of water in one trap. The other trap in the dual choice trapping assay contained 0.4 ml of water plus a separate vial containing 10 μl of DMSO. Twenty 3-4 day old, 24 hours starved flies (males and females) were given a choice between the two traps. After 24 hours, flies in both traps were counted. FIG. 5 (N=10) shows a graph showing the percentage of flies caught per trap when one trap contained water and DMSO only (at right) and the other trap contained water and DMSO plus various amounts of nonanal (at left). At the bottom of the graph, both traps contained water only to show that fruit flies were trapped equally in both traps. N=10. The results show that adding a vial containing nonanal at various concentrations, dissolved in DMSO, to a separate water lure does not trap any more flies than traps containing water and DMSO only.

### Example 6

### Fruit Fly

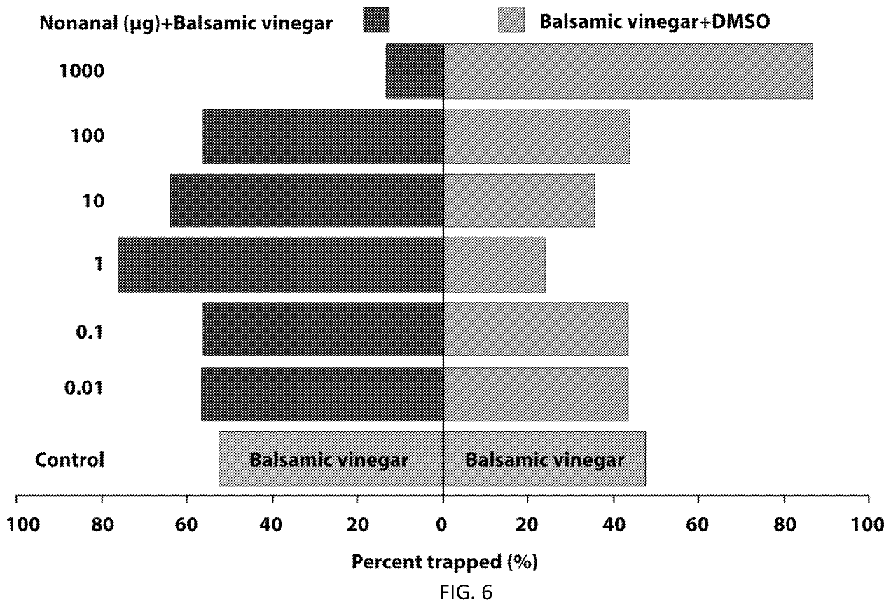

The attraction of starved Drosphila melanogaster males and females to balsamic vinegar to which various amounts of nonanal were added is shown in FIG. 6. The experiment was conducted using the same methodology as shown in FIG. 4. Various amounts of nonanal were dissolved in DMSO, and then 10 μl of nonanal DMSO solution were placed in a separate glass vial adjacent to 0.4 ml of balsamic vinegar in one trap. The other trap in the dual choice trapping assay contained 0.4 ml of balsamic vinegar plus a separate vial containing 10 μl of DMSO. Twenty 3-4 day old, 24 hours starved flies (males and females) were given a choice between the two traps. After 24 hours, flies in both traps were counted. FIG. 6 (N=10) shows a graph showing the percentage of flies caught per trap when one trap contained balsamic vinegar and DMSO only (at right) and the other trap contained balsamic vinegar and DMSO plus various amounts of nonanal (at left). At the bottom of the graph, both traps contained balsamic vinegar only to show that fruit flies were trapped equally in both traps. N=10. The results show that, generally, more flies are trapped as the amount of nonanal (e.g., 1 μg), dissolved in DMSO, increases in a vial adjacent to balsamic vinegar. However, as indicated by the results with the highest amount of nonanal (1000 μg), too much nonanal interferes with attraction of flies to balsamic vinegar.

### Example 7

### Fruit Fly

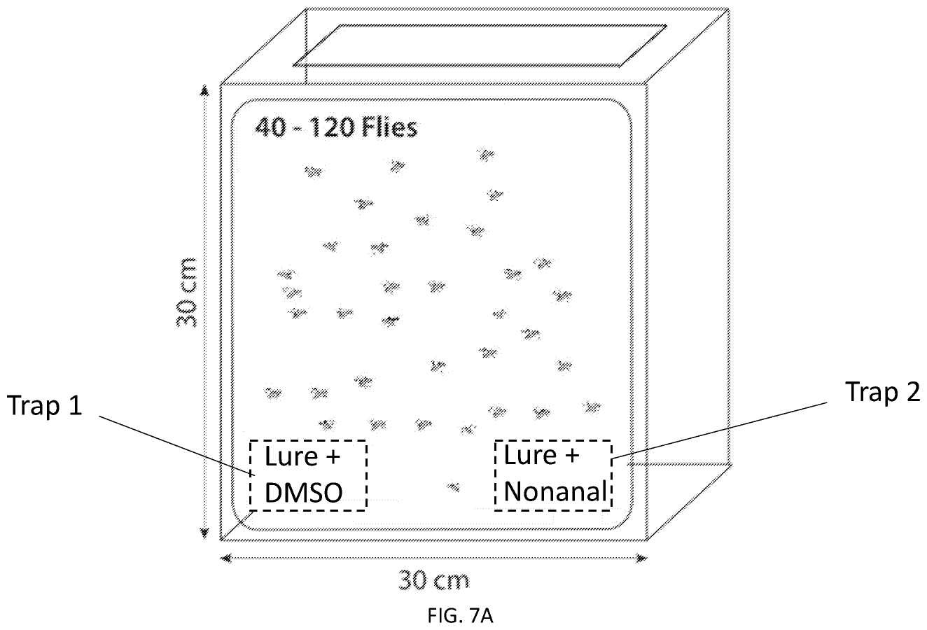

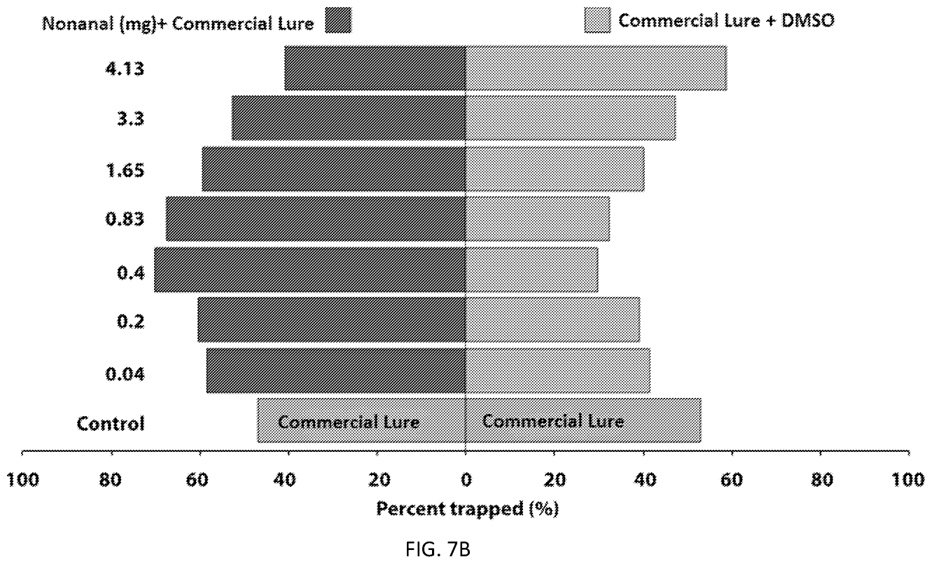

The attraction of starved Drosphila melanogaster males and females to a commercial lure and trap to which various amounts of nonanal were added is shown in FIG. 7B. In all experiments, 40 to 120 3-4 day old, 24 hours starved flies (males and females) were given a choice between two commercial fruit fly traps (sold under the tradename TERRO® traps; Model #BT2502; Senoret Chemicals Co., Inc., Lititz, Pennsylvania, United States of America). See FIG. 7A, which shows a schematic diagram of the dual-choice trapping cage assay. Inside a 30×30 cm cage (sold under the tradename BUGDORM™; MegaView Science Co., Ltd., Taichung, Taiwan), 2 fruit fly traps were arranged diagonally at opposite corners. 1 mL of a commercial fruit fly lure (sold under the tradename TERRO®; Senoret Chemicals Co., Lititz, Pennsylvania, United States of America) was added inside each trap along with 50 μL of DMSO only or 50 μL of DMSO containing nonanal in a ˜1.5 mL glass vial (12×32 mm, Thermo Fisher Scientific, Waltham, Massachusetts, United States of America). After 24 hours, flies in both traps were counted. First, a control experiment was conducted. The bottom of FIG. 7B shows the percentage of flies caught per trap when both traps contained 1 mL of commercial fruit fly lure only. Fruit flies were trapped equally in both traps. N=10.

Various amounts of nonanal were dissolved in DMSO, and then 50 μl of nonanal DMSO solution was added to a ˜1.5 mL glass vial and placed inside a fruit fly trap that contained 1 mL of commercial fruit fly lure (left). The other fruit fly trap in the dual choice trapping assay contained 1 mL of the commercial fruit fly lure plus a ˜1.5 mL glass vial containing 50 μl of DMSO (right). Forty to 120 3-4 day old, 24 hours starved flies (males and females) were given a choice between the two fruit fly traps. After 24 hours, flies in both traps were counted. The results show that more flies are trapped as the amount of nonanal, dissolved in DMSO, increases in the fruit fly lure. Too much nonanal interferes with attraction of flies to the commercial fruit fly lure.

### Example 8

### House Fly

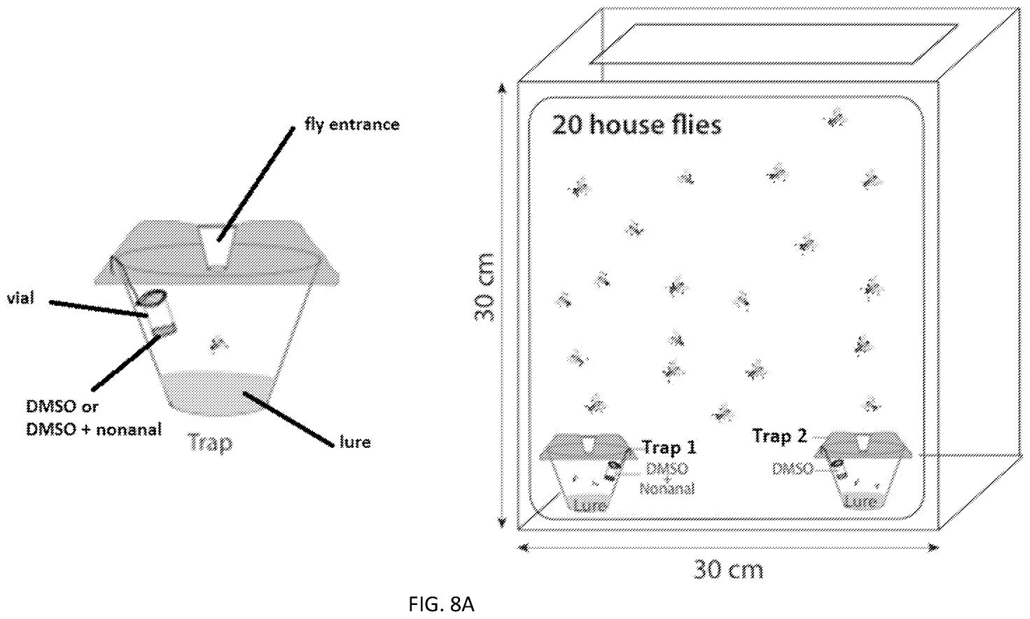

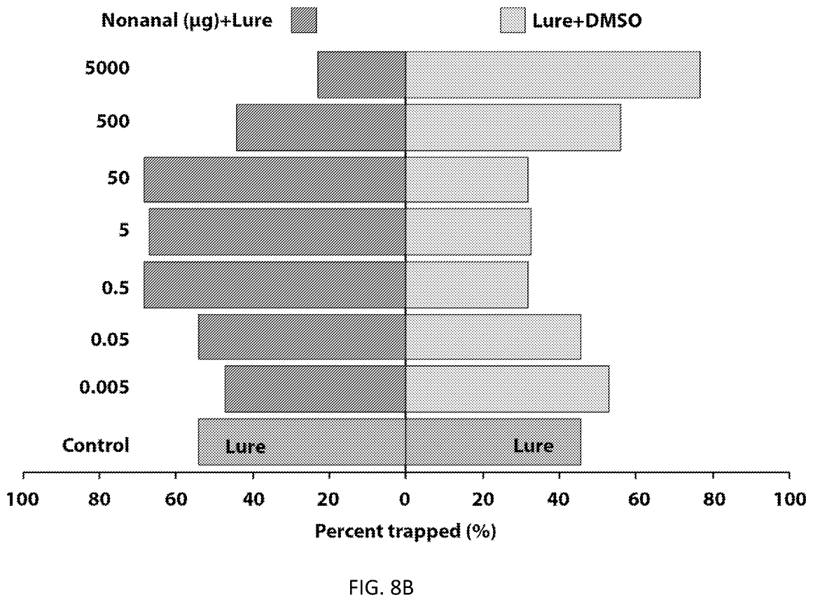

The attraction of fed Musca domestica males and females to a commercial lure and a laboratory-built trap to which various amounts of nonanal were added is shown in FIG. 8A. The traps were built using a 10 oz transparent plastic cup with a transparent green color lid (sold under the tradename Fly-Lid; Billy-Bob, Hardin, Illinois, United States of America). In all the experiments a commercial fly trap attractant (sold under the tradename STARBAR® Fly Trap Attractant; Wellmark International, Phoenix, Arizona, United States of America) was used as a lure. In all experiments, 20 3-4 day old, fed house flies (males and females) were given a choice between two traps with the lure. See FIG. 8A, which shows a schematic diagram of the dual-choice trapping cage assay. Inside a 30×30 cm cage (sold under the tradename BUGDORM™; MegaView Science Co., Ltd., Taichung, Taiwan), 2 house fly traps were arranged diagonally at opposite corners. 50 mL of the commercial fly trap attractant lure was added inside each trap along with 50 μL of DMSO only or 50 μL of DMSO with nonanal in a ˜1.5 mL glass vial (12×32 mm, Thermo Fisher Scientific, Waltham, Massachusetts, United States of America). After 24 hours, house flies in both traps were counted. First, a control experiment was conducted. The bottom of FIG. 8B shows the percentage of house flies caught per trap when both traps contained 50 mL of the commercial fly trap attractant lure only. House flies were trapped equally in both traps. N=6.

Various amounts of nonanal were dissolved in DMSO, and then 50 μl of nonanal DMSO solution was added to a ˜1.5 mL glass vial that contained 50 mg of deactivated glass wool and covered with aluminum foil. The nonanal dispenser was suspended with a paper clip inside the trap containing 50 mL of the commercial fly trap attractant lure on one side.

The other trap in the dual choice trapping assay contained 50 mL of the commercial fly trap attractant lure plus a 50 μl of DMSO only. Twenty 3-4 day old, fed houseflies (males and females) were given a choice between the two traps. After 24 hours, flies in both traps were counted. The results show that more house flies are trapped as the amount of nonanal, dissolved in DMSO, increases in the commercial fly trap attractant lure (N=6). Too much nonanal interferes with attraction of flies to the commercial fly trap attractant lure (N=6).

### Example 9

### Combinations of Nonanal and 1-Hexanol in Attracting Male CEW

The sex pheromone glands of multiple CEW females were dissected and the contents extracted with hexane. The hexane extract was concentrated. Then, a gas chromatograph coupled to an electroantennogram detector (GC-EAD) was used to identify biologically active compounds that are perceived by the antenna of CEW males, since the antenna is the main olfactory organ of insects. The GC separates chemical mixes into individual compounds and directs them to the insect antenna, which is connected to an amplifier, the EAD. In parallel to the GC, the electrophysiological response of the antenna is recorded to identify the active compounds. An aliquot of the pheromone gland extract was injected in the GC-EAD where a male CEW antenna was mounted. Clean hexane that was handled in the same manner without glands was used as control. Gland extracts were also analyzed using gas chromatography-mass spectrometry (GC-MS) (6890 GC and 5975 MS, Agilent Technologies, Palo Alto, California, United States of America) The GC-MS was operated in pulsed splitless mode (15 psi for 0.5 min, then 6 psi) and equipped with a DB-WAXetr column (30 m×0.25 mm, df=0.25 μm, Agilent Technologies, Palo Alto, California, United States of America), and helium was used as the carrier gas at an average velocity of 34 cm/s. The oven program was set to 40° C. for 2 min, increased at 10° C./min to 250° C. Injector temperature was set to 250° C., transfer line temperature was 260° C., and MS quadrupole was 150° C. The mass-to-charge ratio range was from 33 to 650. Compounds were identified based on Kovats indices, electron ionization mass spectra and comparison with authentic synthetic standards.

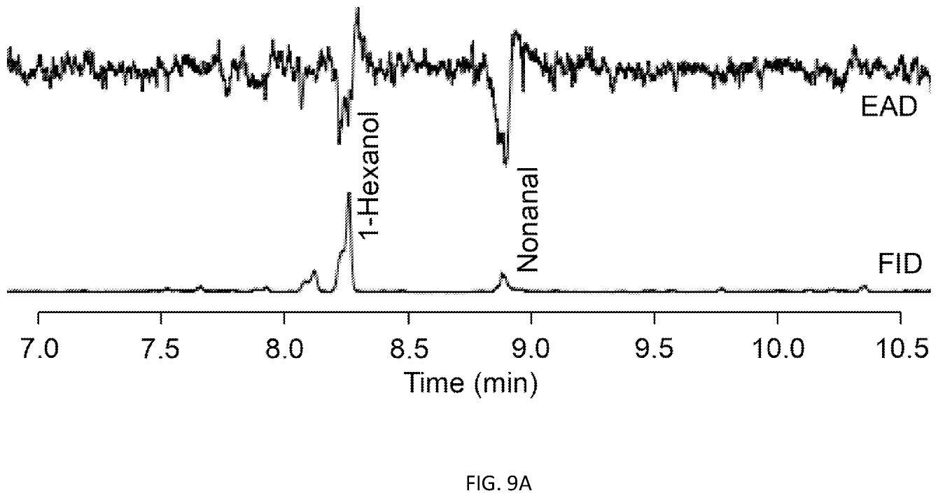

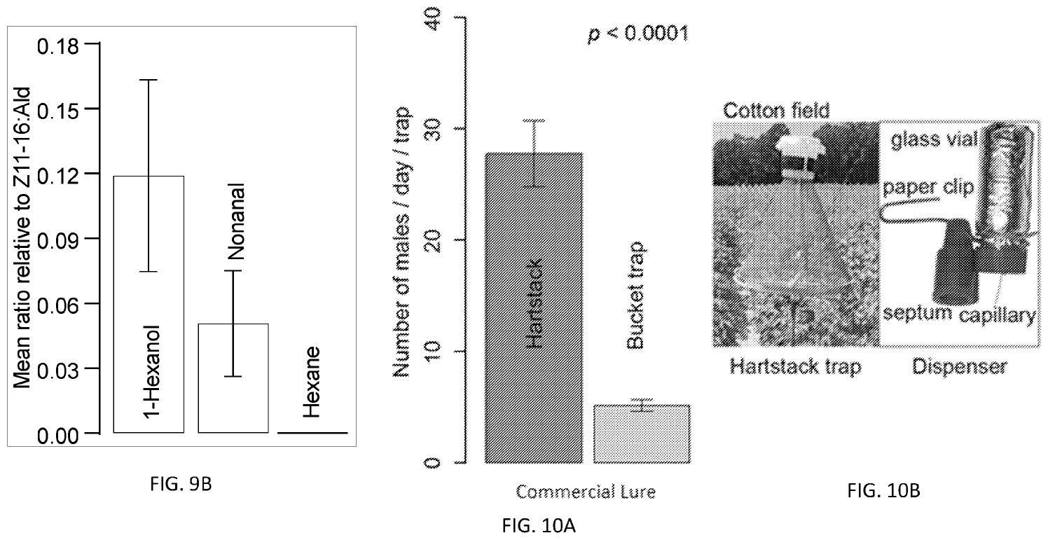

The results of the electrophysiology study indicated that nonanal and 1-hexanol were both components of the CEW sex pheromone. See FIG. 9A. Further studies were conducted using GC-MS to determine the ratio of nonanal and 1-hexanol to the main component of the CEW female sex pheromone gland extract, i.e., Z-11-hexadecenal (Z11-16:Ald). See FIG. 9B.

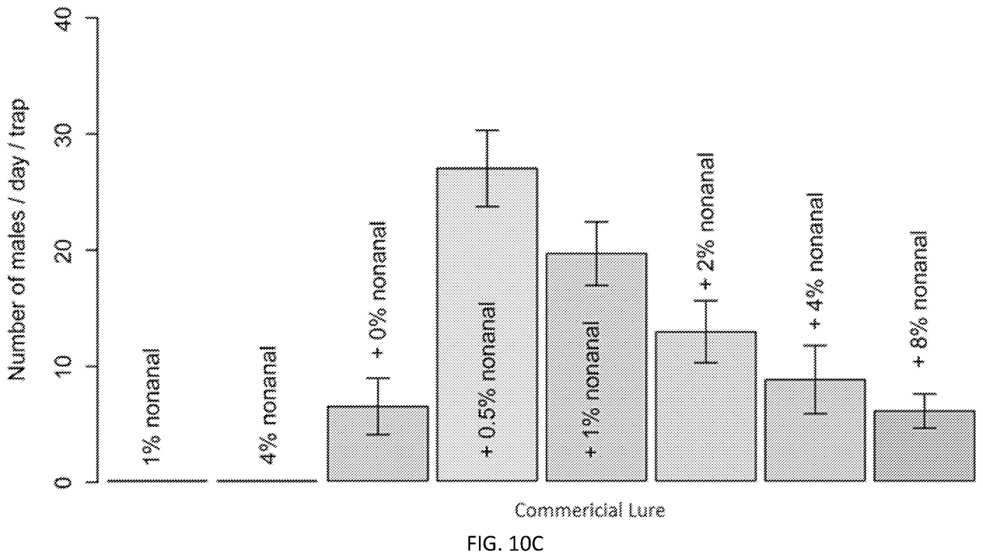

As part of determining the experimental set-up for field studies to investigate the effectiveness of 1-hexanol and combinations of 1-hexanol and nonanal in trapping CEW, initial trapping studies were conducted to determine which type of trap, i.e., a cone-style Hartstack trap or a bucket trap, was most effective in capturing male CEW. Hartstack traps and bucket traps were equipped with a commercially available CEW sex pheromone lure (TC/CO-3138-25, Trece Incorporated, Adair, Oklahoma, United States of America). FIG. 10A shows the number of male corn earworms caught per trap per day using the different types of traps. As the Hartstack traps appeared more effective, they were used for further studies.

The Hartstack traps each include a conical body made of metal mesh with a removal top (H:15 cm, ∅=14 cm) As shown in FIG. 10B, each Harstack trap was equipped with a glass vial covered with aluminum foil and containing a paraffin oil solution of nonanal. Some of the traps also contained, adjacent to the glass vials, a lure comprising a rubber septum formulated with the commercial CEW sex pheromone. Assuming that the commercial pheromone lure contained about 2 mg of the major component (i.e., (Z)-11-hexadecenal), the solutions in the glass vials were prepared to contain various amounts (0%, 0.5%, 1%, 2%, 4%, or 8%) of nonanal on a weight to weight basis with the (Z)-11-hexadecenal. As shown in FIG. 10C, traps containing only nonanal were not effective in capturing male CEW. However, adding nonanal, e.g. 0.5% to 4% nonanal, to a trap including a commercial CEW sex pheromone increased the trap effectiveness.

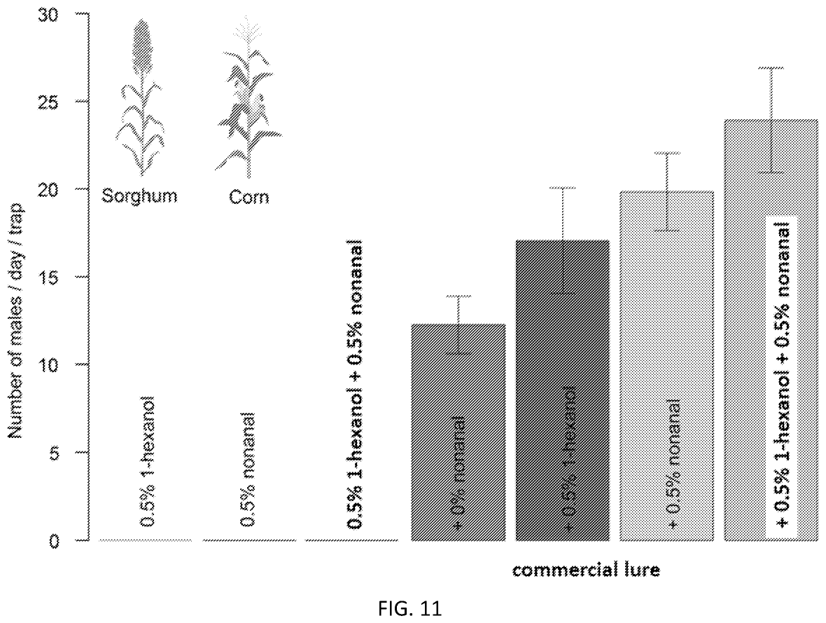

To determine the effects of 1-hexanol and combinations of 1-hexanol and nonanal, Hartstack traps with or without the commercial CEW sex pheromone lure and with or without one or both of nonanal and 1-hexanol were placed in sorghum or corn fields. Nonanal and 1-hexanol, if present, were present at 0.5% on a weight to weight basis with the major component of the commercial pheromone lure. As shown in FIG. 11, without the commercial pheromone lure, 1-hexanol, nonanal, and combinations of 1-hexanol and nonanal were not effective in trapping male CEW, at least at the levels studied. However, when used in combination with the commercial lure, both 1-hexanol and nonanal improved its effectiveness. The best results were observed when 1-hexanol and nonanal were both used with the commercial lure, where 1-hexanol and nonanal appeared to have at least additive effects in improving the effectiveness of the commercial pheromone lure.

It will be understood that various details of the presently disclosed subject matter can be changed without departing from the scope of the presently disclosed subject matter. Furthermore, the foregoing description is for the purpose of illustration only, and not for the purpose of limitation.

1. A composition for attracting an insect, wherein said composition comprises:
a first active component, wherein said first active component comprises at least one C7-C11 aldehyde; and
a second active component, wherein the second active compound comprises at least one of an aggregation pheromone, a kairomone, a food, and a fermentation-based attractant.

2. The composition of claim 1, wherein the first active component comprises or consists of nonanal.

3. The composition of claim 1, wherein the insect is an agricultural or forest pest.

4. The composition of claim 3, wherein the insect is an agricultural pest and wherein said agricultural pest is a Cotinis species or a Drosophila species, optionally Cotinis nitida or Drosophila melanogaster.

5. The composition of claim 1, wherein the insect is a Musca species, optionally Musca domestica.

6. The composition of claim 1, wherein the first active component and/or the second active component is formulated in a slow-release formulation, optionally wherein said slow-release formulation comprises an oil.

7. The composition of claim 1, further comprising a killing agent, a slow-acting insecticide, and/or a biological agent, optionally wherein said biological agent is selected from a bacteria, a fungi, a virus, a nucleic acid, a peptide, and a nematode, optionally wherein said killing agent is a fast-acting insecticide.

8. A method of attracting an insect, the method comprising providing one or more baits or lures, wherein said one or more baits or lures comprise a single active component, wherein said single active component is a C7-C11 aldehyde.

9. The method of claim 8, wherein the C7-C11 aldehyde is nonanal.

10. A method of attracting an insect, the method comprising providing one or more baits or lures, wherein said one or more baits or lures collectively comprise (a) a first active component, wherein said first active component comprises at least one C7-C11 aldehyde; and (b) a second active component, wherein said second active component comprises at least one of an aggregation pheromone, a kairomone, a food, and a fermentation-based attractant.

11. The method of claim 10, wherein the first active component is nonanal.

12. The method of claim 10, wherein the insect is an agricultural pest, optionally wherein the agricultural pest is a Cotinis species or a Drosophila species, further optionally wherein the insect is Cotinis nitida or Drosophila melanogaster.

13. The method of claim 10, wherein the insect is a Musca species, optionally Musca domestica.

14. The method of claim 10, wherein one or both of the first and the second active component is formulated in a slow-release formulation, optionally wherein the first component is formulated in an oil or an alkane.

15. The method of claim 10, wherein the second component comprises a vinegar or 2-propanol.

16. The method of claim 10, wherein the one or more baits or lures are provided in association with a housing for trapping one or more insect.

17. A method of attracting a male insect of the genus Helicoverpa, Chloridea, or Heliothis, the method comprising providing one or more baits or lures, wherein said one or more baits or lures collectively comprise:
(a) a first active component, wherein said first active component comprises at least one C7-C11 aldehyde and/or 1-hexanol; and
(b) a second active component, wherein said second active component comprises a sex pheromone of said insect.

18. The method of claim 17, wherein the male insect is a corn earworm or a tobacco budworm.

19. The method of claim 17, wherein the first active component comprises or consists of nonanal and/or wherein the second active component comprises or consists of (Z)-11-hexadecenal (Z11-16:Ald) and/or (Z)-9-tetradecenal (Z9-14:Ald).

20. A composition for attracting a male insect of the genusHelicoverpa, Chloridea, or Heliothis, wherein the composition comprises (i) a first active component comprising 1-hexanol; and (ii) a second active component comprising at least one of (Z)-11-hexadecenal and (Z)-9-tetradecenal.

21. The composition of claim 20, wherein the first active component further comprises nonanal.
